(19) United States
(12) Patent Application Publication
(10) Pub. No.: US 2026/0025229 A1
(43) Pub. Date: Jan. 22, 2026

(54) ENHANCED RATE MATCHING USER INFORMATION TECHNIQUES AND EXTENDED LONG RANGE HIGH RELIABILITY WIRELESS COMMUNICATION PROTOCOLS

(71) Applicants: Laurent Cariou, Milizac (FR); Juan Fang, Portland, OR (US); Qinghua Li, San Ramon, CA (US); Danny Alexander, Neve Efraim Monoson (IL); Robert Stacey, Portland, OR (US); Shlomi Vituri, Tel Aviv (IL)

(72) Inventors: Laurent Cariou, Milizac (FR); Juan Fang, Portland, OR (US); Qinghua Li, San Ramon, CA (US); Danny Alexander, Neve Efraim Monoson (IL); Robert Stacey, Portland, OR (US); Shlomi Vituri, Tel Aviv (IL)

(21) Appl. No.: 19/290,133

(22) Filed: Aug. 4, 2025

Related U.S. Application Data
(60) Provisional application No. 63/681,585, filed on Aug. 9, 2024.
(60) Provisional application No. 63/681,676, filed on Aug. 9, 2024.
(60) Provisional application No. 63/686,145, filed on Aug. 22, 2024.
(60) Provisional application No. 63/707,327, filed on Oct. 15, 2024.

(51) Int. Cl. H04L 1/00

(52) U.S. Cl. CPC H04L 1/0057; H04L 1/0008; H04L 1/0068

(57) ABSTRACT

This disclosure describes systems, methods, and devices related to enhanced connectivity. A device may receive a data payload and modulation and coding scheme (MCS) information for transmission. The device may select a low-density parity-check (LDPC) codeword size based on the data payload size and the MCS information. The device may encode the data payload into at least one LDPC codeword according to the selected LDPC codeword size. The device may transmit the encoded LDPC codeword using a wireless interface.

### CROSS-REFERENCE TO RELATED APPLICATIONS

This application claims the benefit of U.S. Provisional Application No. 63/707,327, filed Oct. 15, 2024, U.S. Provisional Application No. 63/686,145, filed Aug. 22, 2024, U.S. Provisional Application No. 63/681,585, filed Aug. 9, 2024, and to U.S. Provisional Application No. 63/681,676, filed Aug. 9, 2024, the disclosures of which are incorporated herein by reference as if set forth in full.

### BACKGROUND

Wireless devices are becoming more prevalent, necessitating efficient access to wireless channels. Standards are evolving to enhance connectivity, integrating advanced technologies in modern networks.

### BRIEF DESCRIPTION OF THE DRAWINGS

FIG. 1 is a network diagram illustrating an example network environment for enhanced connectivity, in accordance with one or more example embodiments of the present disclosure.

FIGS. 2A-2B depict illustrative schematic diagrams for ELR LDPC Advancement, in accordance with one or more example embodiments of the present disclosure.

FIGS. 3-4, 5A-5B, 6A-6B, 7A-7C, and 8A-8C depict illustrative schematic diagrams for UHR ELR Enhancement, in accordance with one or more example embodiments of the present disclosure.

FIGS. 9A-9B depict illustrative schematic diagrams for ELR preamble, in accordance with one or more example embodiments of the present disclosure.

FIG. 10 illustrates a flow of a process for an illustrative enhanced connectivity system, in accordance with one or more example embodiments of the present disclosure.

FIG. 11 illustrates a functional diagram of an exemplary communication station that may be suitable for use as a user device, in accordance with one or more example embodiments of the present disclosure.

FIG. 12 illustrates a block diagram of an example machine upon which any of one or more techniques (e.g., methods) may be performed, in accordance with one or more example embodiments of the present disclosure.

FIG. 13 is a block diagram of a radio architecture in accordance with some examples.

FIG. 14 illustrates an example front-end module circuitry for use in the radio architecture of FIG. 13, in accordance with one or more example embodiments of the present disclosure.

FIG. 15 illustrates an example radio IC circuitry for use in the radio architecture of FIG. 13, in accordance with one or more example embodiments of the present disclosure.

FIG. 16 illustrates an example baseband processing circuitry for use in the radio architecture of FIG. 13, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

This disclosure relates to advancements in wireless communication protocols within the IEEE 802.11bn standard, focusing on Extended Long Range (ELR) and high reliability features. The described techniques encompass enhanced rate matching and user information methods for non-ELR PPDUs, improved physical layer (PHY) designs for ultra-high reliability ELR PPDUs, MAC layer support for ELR PHY operations, and novel preamble structures. Collectively, these innovations aim to optimize range, reliability, and efficiency in wireless transmissions, supporting robust and efficient connectivity in evolving wireless network environments.

Wi-Fi 8 (IEEE 802.11bn or ultra high reliability (UHR)) is the next generation of Wi-Fi and a successor to the IEEE 802.11be (Wi-Fi 7) standard. In line with all previous Wi-Fi standards, Wi-Fi 8 will aim to improve wireless performance in general along with introducing new and innovative features to further advance Wi-Fi technology.

Extended long range (ELR) was being discussed as one of the main 802.11bn features to improve the transmission range. The two MCSs under discussion is MCS0: BPSK with R=½, 24 bits per OFDM symbol and MCS1: QPSK with R=½, 48 bits per OFDM symbol. Due to the extremely low data rate, the existing LDPC rate matching will not work well, which shows large puncturing or shortening rate.

IEEE 802.11bn is likely to have an enhanced long-range mode (ELR). It is desired that the transmission power of ELR can be increased for long range applications. In this disclosure, designs for two ELR fields, namely ELR-Mark and ELR-Data, are proposed. The designs enable transmission powers or diversity gain higher than the existing proposals from other companies.

It was proposed to use two OFDM symbols right after U-SIG field as the ELR-Mark field. The ELR-Mark field was initially for the receiver to identify the ELR-PPDU. Few months before, it was proposed to send BPSK sequences in frequency domain over the two OFDM symbols for signaling BSS color, i.e., a short version of BSS ID. Because they wanted to support 64 sequences for 64 BSS colors, respectively, some sequences have higher PAPRs than the others. In this disclosure, additional details are provided for the ideas.

The data transmission of ELR employs four duplicated 52-tone-RUs (RU52s or RRU52s) in 20 MHz. Three solutions QCM, MTK, and NXP are proposed to divide the four duplicated 52-tone-RUs into eight parts, where each 52-tone-RU is divided into two continuous parts. The data symbols in each part are masked by a common phase, +1 or −1. The BRM solution provides for a different scheme. For each 52-tone-RU, a different length-4 BPSK sequence is repeatedly masked with the data symbols. A different solution is proposed, which outperforms the solutions proposed by the other companies. In this disclosure, the design is slightly modified to accommodate a recently decided pilot transmission that affects the overall Peak-to-Average Power Ratio (PAPR).

Also, for the purpose of increasing transmission power, tone plans have been proposed. Following recent discussions among a few companies about pilot locations, the tone plan has been slightly modified accordingly.

The new ELR PPDU may increase the range at which the PPDU can be received. A set of MAC rules is needed in order to regulate the usage of ELR PPDUs by STAs and APs.

It is desired that the ELR preamble is backward compatible to the legacy as much as possible. In this disclosure, it is proposed to have at least two backward compatible techniques, i.e., pilot power boosting and rate matching indication, which are used in the ELR preamble.

It was proposed to boost the power of the pilot signals in L-SIG, RL-SIG, and U-SIG. The power boosting level is further specified in this disclosure.

Rate matching scheme was proposed and its indication for ELR. An alternative is proposed based on IEEE 802.11n rate matching in this disclosure.

Example embodiments of the present disclosure relate to systems, methods, and devices for enhanced rate matching and user information techniques for NON-ELR PPDU in 802.11bn.

In this disclosure, several methods to mitigate the above problems are proposed.

ELR LDPC rate matching, ELR-SIG and non-MU-MIMO user info for non-ELR PPDU in 802.11bn.

Several solutions are proposed to enhance the existing LDPC rate matching algorithm to mitigate the large puncturing/shortening ratio issue for ELR PPDU transmission when LDPC is used.

The proposed solutions can simplify reducing the puncturing or shortening ratio for ELR PPDU transmission.

Further example embodiments of the present disclosure relate to systems, methods, and devices for Enhanced Designs for UHR ELR PPDU.

In one embodiment, a UHR ELR Enhancement system may facilitate:
1. The general form of the best mask sequence for the 8-part masking proposed by other companies is identified, allowing for the derivation of many equivalent mask sequences from the general form.
2. Length-2 mask sequences are improved according to a recently decided pilot scheme.
3. The tone plan is modified in accordance with newly decided pilot locations.
4. Design details are provided about non-orthogonal or quasi-orthogonal sequences for BSS color indication. It is suggested that different sequences with good separation and good PAPRs can be generated from one or few low-PAPR sequences with different global phase rotations and other transformations. The concept of global phase rotation is applicable in conjunction with another method.
5. For the lowest data rate, the use of QPSK with code rate ½ and 8 signal repetitions is proposed, as opposed to the current BPSK with code rate ½ and 4 signal repetitions.

The ELR improves the coverage of laptop connections such that the user experience gets improved.

Further example embodiments of the present disclosure relate to systems, methods, and devices for WiFi8—MAC support for ELR PPDU.

In one embodiment, a MAC support ELR system may facilitate some simple MAC rules in order to regulate the usage of ELR PPDU by ultra-high reliability (UHR) station devices (STAs).

It is also proposed that buffer status report poll (BSRP) Trigger frame may solicit a response using a non-HT (Duplicate) PPDU or ELR PPDU.

It is also proposed to define an ELR (Duplicate) PPDU, by simply duplicating the ELR PPDU generated on 20 MHz over the transmit opportunity (TXOP) BW.

Further example embodiments of the present disclosure relate to systems, methods, and devices for ELR Preamble.

In one or more embodiments, a ELR preamble system may facilitate power boost the pilot signals in L-SIG, RL-SIG, U-SIG to the same power level of L-LTF. Second, a rate matching scheme is proposed based on 11n instead of 11ac for ELR. Namely, the LENGTH field in ELR-SIG indicates the payload size instead of the PPDU duration. By doing so, the padding overhead can be reduced and the indication bit of LDPC extra symbol(s) or LDPC extra symbol segment is not needed.

The ELR improves the coverage of laptop Wi-Fi such that the user experience gets improved.

It is understood that the above descriptions are for the purposes of illustration and are not meant to be limiting.

In one or more embodiments, a device or a system may comprise one or more components, which may include one or more of: apparatus, station (STA), access point (AP), and/or other network elements. At its most basic configuration, the device or system includes one or more processors, memory, and instructions. The processor(s) may be implemented using general-purpose microprocessors, digital signal processors (DSPs), field-programmable gate arrays (FPGAs), or other suitable computational entities capable of performing calculations or manipulations of information. The memory may include RAM, ROM, flash memory, or other storage media suitable for storing instructions and data necessary for system operation. These components, individually or in combination, enable the execution of processes that facilitate communication and functionality within the system.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

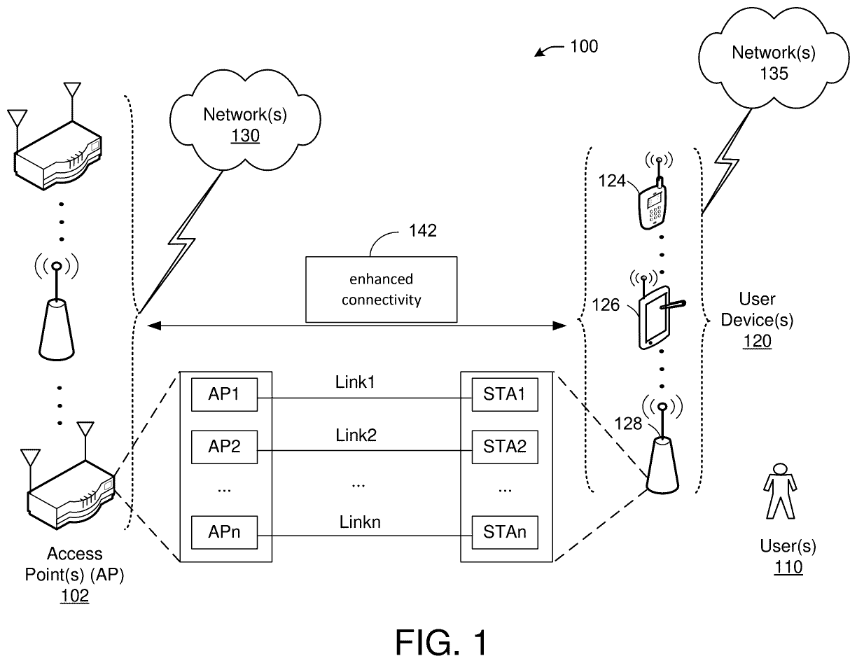

FIG. 1 is a network diagram illustrating an example network environment of enhanced connectivity, according to some example embodiments of the present disclosure. Wireless network 100 may include one or more user devices 120 and one or more access points(s) (AP) 102, which may communicate in accordance with IEEE 802.11 communication standards. The user device(s) 120 may be mobile devices that are non-stationary (e.g., not having fixed locations) or may be stationary devices.

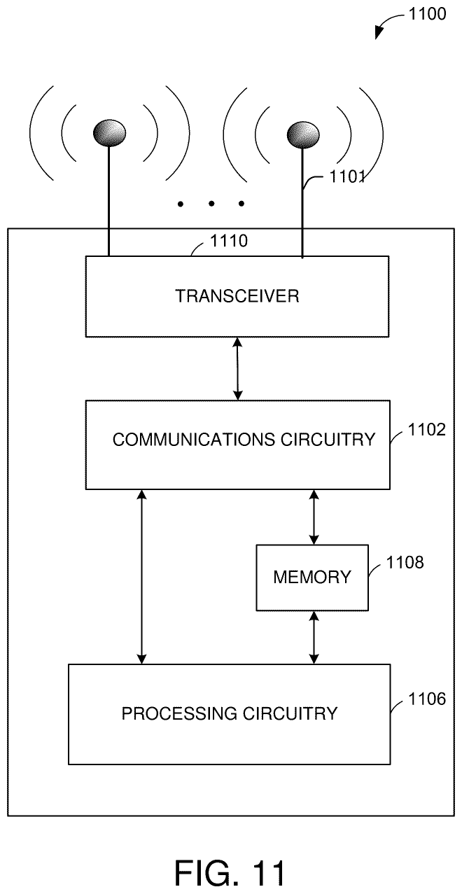

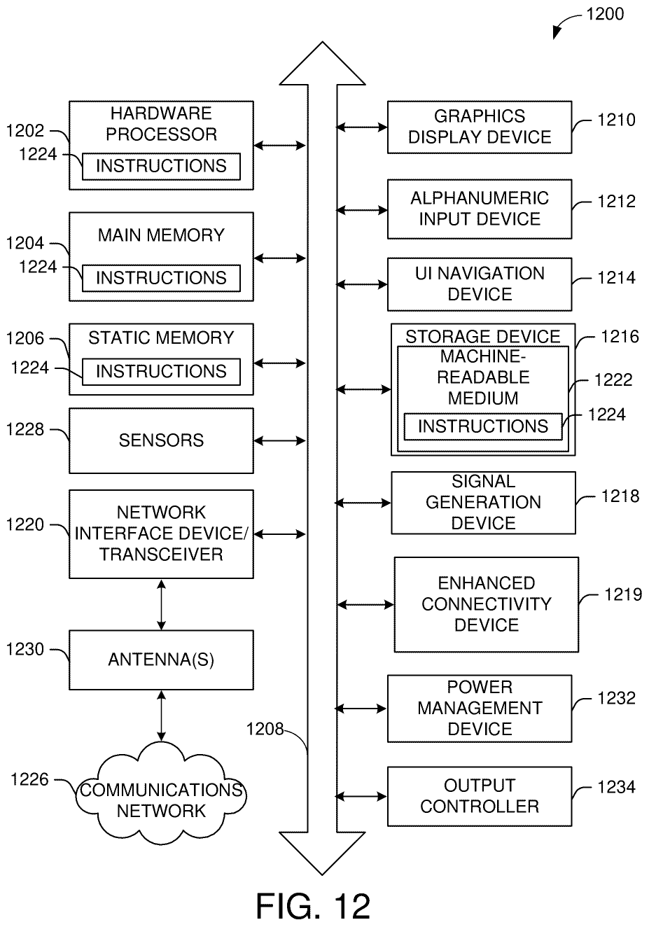

In some embodiments, the user devices 120 and the AP 102 may include one or more computer systems similar to that of the functional diagram of FIG. 11 and/or the example machine/system of FIG. 12.

One or more illustrative user device(s) 120 and/or AP(s) 102 may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QOS) STA, a dependent STA, and a hidden STA. The one or more illustrative user device(s) 120 and the AP(s) 102 may be STAs. The one or more illustrative user device(s) 120 and/or AP(s) 102 may operate as a personal basic service set (PBSS) control point/access point (PCP/AP). The user device(s) 120 (e.g., 124, 126, or 128) and/or AP(s) 102 may include any suitable processor-driven device including, but not limited to, a mobile device or a non-mobile, e.g., a static device. For example, user device(s) 120 and/or AP(s) 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IOT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP(s) 102 may also include mesh stations in, for example, a mesh network, in accordance with one or more IEEE 802.11 standards and/or 3GPP standards.

Any of the user device(s) 120 (e.g., user devices 124, 126, 128), and AP(s) 102 may be configured to communicate with each other via one or more communications networks 130 and/or 135 wirelessly or wired. The user device(s) 120 may also communicate peer-to-peer or directly with each other with or without the AP(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide arca networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP(s) 102 may include one or more communications antennas. The one or more communications antennas may be any suitable type of antennas corresponding to the communications protocols used by the user device(s) 120 (e.g., user devices 124, 126 and 128), and AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP(s) 102.

Any of the user device(s) 120 (e.g., user devices 124, 126, 128), and AP(s) 102 may be configured to perform directional transmission and/or directional reception in conjunction with wirelessly communicating in a wireless network. Any of the user device(s) 120 (e.g., user devices 124, 126, 128), and AP(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP(s) 102 may be configured to perform any given directional transmission towards one or more defined transmit sectors. Any of the user device(s) 120 (e.g., user devices 124, 126, 128), and AP(s) 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP(s) 102 may be configured to use all or a subset of its one or more communications antennas to perform MIMO beamforming.

Any of the user devices 120 (e.g., user devices 124, 126, 128), and AP(s) 102 may include any suitable radio and/or transceiver for transmitting and/or receiving radio frequency (RF) signals in the bandwidth and/or channels corresponding to the communications protocols utilized by any of the user device(s) 120 and AP(s) 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax, 802.11be, 802.11bn, etc.), 6 GHz channels (e.g., 802.11ax, 802.11be, 802.11bn, etc.), or 60 GHZ channels (e.g. 802.11ad, 802.11ay). 800 MHz channels (e.g. 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one embodiment, and with reference to FIG. 1, a user device 120 may be in communication with one or more APs 102. For example, one or more APs 102 may implement a enhanced connectivity 142 with one or more user devices 120. The one or more APs 102 may be multi-link devices (MLDs) and the one or more user device 120 may be non-AP MLDs. Each of the one or more APs 102 may comprise a plurality of individual APs (e.g., AP1, AP2, . . . , APn, where n is an integer) and each of the one or more user devices 120 may comprise a plurality of individual STAs (e.g., STA1, STA2, . . . , STAn). The AP MLDs and the non-AP MLDs may set up one or more links (e.g., Link1, Link2, . . . , Linkn) between each of the individual APs and STAs. It is understood that the above descriptions are for the purposes of illustration and are not meant to be limiting.

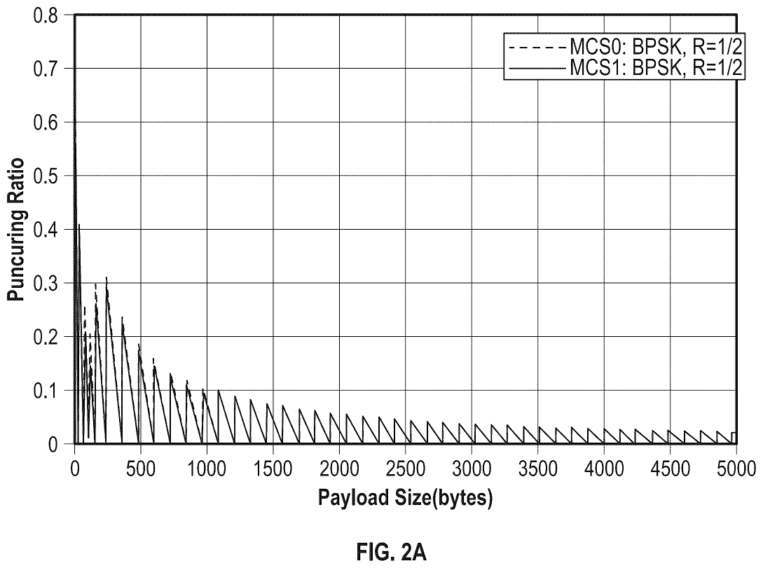

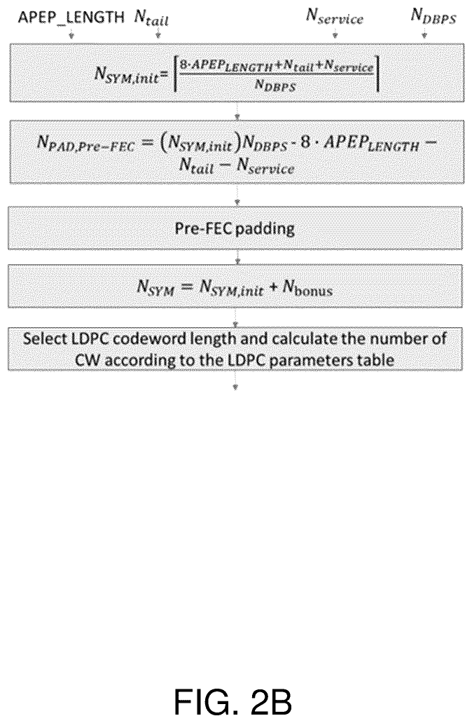

FIGS. 2A-2B depict illustrative schematic diagrams for ELR LDPC Advancement, in accordance with one or more example embodiments of the present disclosure.

Extended long range (ELR) was being discussed as one of the main 802.11bn features to improve the transmission range. The two MCSs under discussion are MCS0: BPSK with R=½, 24 bits per OFDM symbol and MCS1: QPSK with R=½, 48 bits per OFDM symbol. Due to the extremely low data rate, the existing LDPC rate matching will not work well, which shows large puncturing or shortening rate as shown in FIG. 2A.

### LDPC Rate Matching Proposal 1:

To reduce the granularity gap between the data rate (number of bits per OFDM symbol) and LDPC codeword size, smaller LDPC codeword size will be used for the small or short ELR PPDU transmission. A new threshold should be used to select different LDPC codewords as shown below. A similar idea has been proposed by other to be used in the non-ELD PPDU LDPC rate matching. The basic principle is to increase the value of N₁ and N₂ to avoid large Puncturing or shortening rate, which cannot be easily solved by simply adding one LDPC extra symbol segment. The value of N₁ and N₂ are to be defined and standardized.

TABLE 1
LDPC parameters:

| Range(bits) of N_{avbits} | N_{CW} | LDPC code word length in bits (L_{LDPC}) |
|---|---|---|
| N_{avbits} ≤ N₁ | $⌈ \frac{{N}_{avbits}}{648} ⌉$ | 648 |
| N₁ < N_{avbits} ≤ N₂ | $⌈ \frac{{N}_{avbits}}{1296} ⌉$ | 1296 |
| N₂ < N_{avbits} | $⌈ \frac{{N}_{avbits}}{1944} ⌉$ | 1944 |

### LDPC Rate Matching Proposal 2:

Adding extra OFDM symbols to the initial number of OFDM symbols calculated based on the data rate and payload to carry the LDPC codewords. Similar idea has been proposed by other to be used in the non-ELD PPDU LDPC rate matching. In other words, the encoded bits (PHY) boundary is equal to the pre-FEC padding (MAC) boundary+extra fixed number of OFDM symbols. Note: the extra OFDM symbol may only be added when the packet size is smaller than certain value, which will be defined in the 802.11 specification (“spec”) for both MCS0 and MCS1.

### LDPC Rate Matching Proposal 3:

The pre-FEC padding factor is fixed to be 4 and ends at the end of the OFDM symbols and the LDPC extra OFDM symbol segment size maybe different for MCS0 and MCS1: For example:

For MCS0, one LDPC extra segment is equal to 4 or 8 OFDM symbols or other numbers.

For MCS1, one LDPC extra segment is equal to 2 or 4 OFDM symbols or other numbers.

The number of signaling bits for LDPC extra symbol segment may be 1 bit or 2 bits or even higher number.

Proposal 1-3 can be combined and used together or separately. Proposal 1 with proposal 2; Proposal 1 with Proposal 3; proposal 2 with Proposal 3; Proposal 1, Proposal 2 and proposal 3are combined together, proposal 1 only, proposal 2 only or proposal 3 only.

Example of LDPC rate matching for ELR PPDU transmission with proposal 1 and proposal 2:

LDPC codeword size selected from 648, 1296 and 1944 will be used to encode the ELR data transmitted to or from each user.

FIG. 2B illustrates the padding process for the ELR PPDU.

The padding process is described as follows:
The R in FIG. 2B is the LDPC code rate.
The MAC boundary (pre-FEC padding boundary) is determined by the data rate and payload size as that in 802.11ac.

$${N}_{PAD , Pre - FEC} = {N}_{s y m , init} \cdot {N}_{N D P S} - ( A P E {P}_{L E N G T H} \times 8 + {N}_{tail , u} + {N}_{s e r v i c e} ) \qquad eq . 1$$

Then several bonus OFDM symbols will be added to the initial number of OFDM symbols and used to calculate the codeword length and the number of codewords according to the LDPC parameters table 1. Note: the number of bonus OFDM symbols will be a fixed standardized value for different packet sizes but maybe different for MCS0 and MCS1. The value is to be defined. One example value for MCS0 is 4 or 8 and one example value for MCS1 is 2 or 4.

After that, it follows the existing LDPC rate matching process to complete the LDPC encoding process.

New LDPC rate matching for ELR PPDU transmission with proposal 3:
The pre-FEC padding will be the same as described above. The LDPC extra symbol segment adding algorithm will be as follows:
Method 1: LDPC extra symbol segment will be indicated by 1 bit.

if

$$( {N}_{p u n c} > 0.1 \times {N}_{C W} \times {L}_{L D P C} ( 1 - R ) AND {N}_{shrt} < 1.2 \times {N}_{p u n c} \times \frac{R}{1 - R} ) OR$$

$$( {N}_{punc} > 0.3 \times {N}_{C W} \times {L}_{LDPC} ( 1 - R ) ) ,$$

one LDPC extra symbol segment will be added and the LDPC extra symbol segment size will depend on the data rate, but is a standardized fixed value.
Method 2: LDPC extra symbol segment will be indicated by 2 or more bits:

If it is indicated by 2 bits, three maximum LDPC extra symbol segments can be added. It can be decided once by checking the puncturing and shortening ratio with three different thresholds or metrics.

Or going through the puncturing and shortening ratio checking until

$$( {N}_{p u n c} > 0.1 \times {N}_{C W} \times {L}_{L D P C} ( 1 - R ) AND {N}_{shrt} < 1.2 \times {N}_{p u n c} \times \frac{R}{1 - R} ) OR$$

$$( {N}_{punc} > 0.3 \times {N}_{C W} \times {L}_{LDPC} ( 1 - R ) )$$

is not true with up to three times if two bit LDPC extra symbol segment is defined.

ELR-SIG design with LDPC rate matching Proposal 3: Additional claim in the ELR-SIG field.

Adding LDPC extra symbol segment field in the ELR-SIG if proposal 3 above is used:

LDPC extra symbol segment:

The number of bits for LDPC extra symbol segment indication may be 1 bit or 2 bits or even more bits.

The segment size may be different for MCS0 and MCS1:

For example, for MCS0, one segment maybe equal to 4 or 8 OFDM symbols or other numbers, for MCS1, one segment maybe equal to 2 or 4 OFDM symbols or other numbers

TABLE 2
Example with 1 bit:

| LDPC extra symbol | | Added number of |
|---|---|---|
| segment bit | MCS | OFDM symbols |
| 0 | 0/1 | 0 |
| 1 | 0 | 4 or 8 |
| 1 | 1 | 2 or 4 |

Example with 2-bit.

Assuming for MCS0, the LDPC extra symbol segment size is N₀, it may be equal to 2 or 3 OFDM symbols.

For MCS1, the LDPC extra symbols segment size is N₁ it may be equal to 1 or 2 OFDM symbols. Then the added LDPC extra symbol segments in term of number of OFDM symbols with MCS MCSᵢ, i=0 or 1 can be calculated as following Table 3:

| LDPC extra symbol | Added number of |
|---|---|
| segment bit | OFDM symbols |
| 0 | 0 |
| 1 | Nᵢ |
| 2 | 2Nᵢ |
| 3 | 3Nᵢ |

Design 1: ELR-SIG filed is of two OFDM symbols carrying the following 48-bit information with LDPC extra symbol segment bit, as shown in Table 3:

| | | | | | | | B14- | B18- |
|---|---|---|---|---|---|---|---|---|
| | B0 | B1 | B2 | B3 | B4-B12 | B13 | B17 | B23 |
| ELR- | ELR- | DL/UL | MCS | Coding | LENGTH | More | CRC | Tail |
| SIG-1 | version | | | | | ELR- | | |
| | | | | | | PPDU | | |

| | | | | B14- | B18- |
|---|---|---|---|---|---|
| | B0-B10 | B11-B12 | B13 | B17 | B23 |
| ELR- | AID | LDPC extra | Reserved | CRC | Tail |
| SIG-2 | | symbol | | | |
| | | segment | | | |

Or

TABLE 4

| | | | | | | | B14- | B18- |
|---|---|---|---|---|---|---|---|---|
| | B0 | B1 | B2 | B3 | B4-B12 | B13 | B17 | B23 |
| ELR- | ELR- | DL/UL | MCS | Coding | LENGTH | LDPC | CRC | Tail |
| SIG-1 | version | | | | | extra | | |
| | | | | | | symbol | | |
| | | | | | | segment | | |

| | | | | B14- | B18- |
|---|---|---|---|---|---|
| | B0-B10 | B11 | B12-B13 | B17 | B23 |
| ELR- | AID | More ELR- | Reserved | CRC | Tail |
| SIG-2 | | PPDU | | | |

Design 2: ELR-SIG filed is of two OFDM symbols carrying the following 48-bit information without LDPC extra symbol segment bit if LDPC rate matching proposal 3 is not used, as shown in Table 5:

| | | | | | | | B14- | B18- |
|---|---|---|---|---|---|---|---|---|
| | B0 | B1 | B2 | B3 | B4-B12 | B13 | B17 | B23 |
| ELR- | ELR- | DL/UL | MCS | Coding | LENGTH | More | CRC | Tail |
| SIG-1 | version | | | | | ELR- | | |
| | | | | | | PPDU | | |

| | | | B14- | B18- |
|---|---|---|---|---|
| | B0-B10 | B11-B13 | B17 | B23 |
| ELR- | AID | Reserved | CRC | Tail |
| SIG-2 | | | | |

ELR PPDU type indication in U-SIG:

ELR PPDU type should be indicated in the U-SIG to be differentiated from non-ELR UHR PPDU, it can be indicated by one or more disregard or validate bit from U-SIG, it can also be indicated by one validate value by the two-bit PPDU type and Compression mode field.

TABLE 6
Non-MU-MIMO user info field design:

| | | | B19 | B20 | B21 | |
|---|---|---|---|---|---|---|
| B0 B10 | B11 B15 | B16-18 | UEQM | UEQM pattern | | B22 |
| STA-ID | MCS | NSS | EQM | BF | 0: BCC | If B21 indicates LDPC |
| | | | | | 1: LDPC | 0: Legacy LDPC |
| | | | | | | 1: 2x LDPC |

B0-B10 will be kept the same for STA-ID.

B11-B15 will be used for the MCS indication with MCS0-MCS15 indication be the same as that in 802.11be.

B16-B18 will be used for the NSS indication supporting up to 8 spatial streams as 802.11be.

B19: EQM/UEQM mode indication bit. Example: 0 for EQM and 1 for UEQM B20-B21:

If B19 is set to be EQM mode.

B20 will be used as BF indication as in EHT.

B21 will be used to indicate whether it is BCC or LDPC as in EHT:

0: BCC.

1: LDPC.

If B19 is set to be UEQM mode, BF and LDPC are used by default.

B20 and B21 may be used to indicate the UEQM patterns as proposed by others.

B22:

If B21 is indicated to be LDPC, it will be used to indicate whether it is legacy LDPC

or 2×LDPC with codeword length of 3888 is used for the PPDU transmission:

0: Legacy LDCP with codeword length up to 1944.

1: 2×LDPC with codeword length of 3888 is used for the current PPDU.

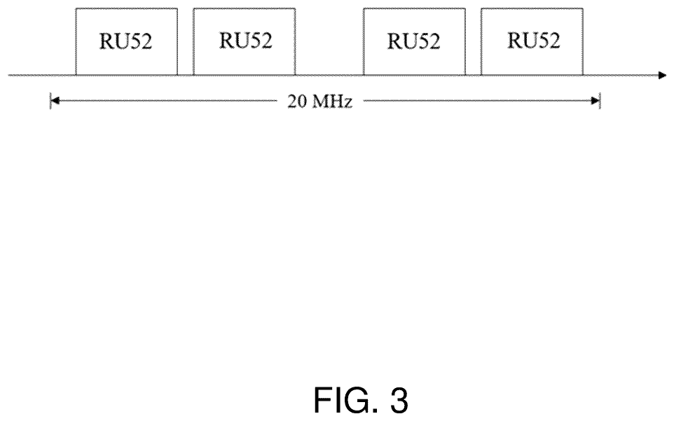

FIGS. 3-4, 5A-5B, 6A-6B, 7A-7C, 8A-8C depict illustrative schematic diagrams for UHR ELR Enhancement, in accordance with one or more example embodiments of the present disclosure.

The data portion of the ELR PPDU will look like the one in FIG. 3. The same data will be sent by the four regular 52-tone-RUs within the 20 MHz. The center 26-tone-RU is not used. Simple duplication of the transmission in each RU by 4 times incurs high peak-to-average power ratios, which is undesirable for increasing the transmission power.

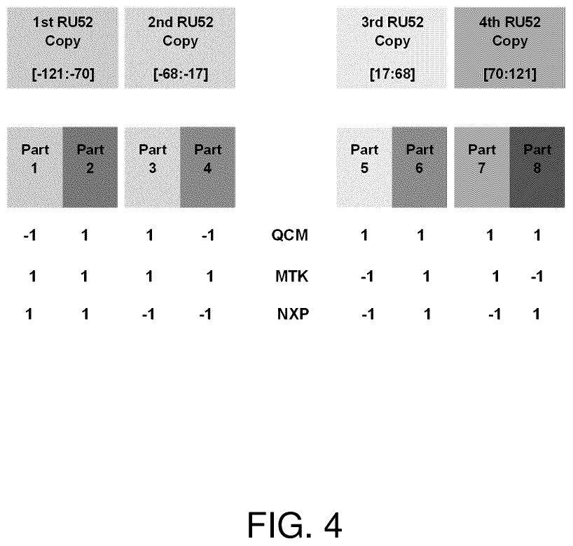

Solutions QCM, MTK, and NXP are illustrated in FIG. 4. Each 52-tone-RU (RU52) in FIG. 3 is divided into two continuous parts (or halves) equally. There are eight parts in total. The symbol on each subcarrier in each part is masked by 1 or −1, i.e., a common BPSK symbol, as illustrated in FIG. 4. The eight BPSK masking symbols form a length-8 sequence. Different companies proposed different length-8 BPSK sequences, respectively as illustrated in FIG. 4. FIG. 4. Solutions QCM, MTK, and NXP.

For the ease of illustration, it is possible to put the masking phases in FIG. 4 into a matrix form as:

$$P = [ \begin{matrix}{p}_{1} & {p}_{2} \\ {p}_{3} & {p}_{4} \\ {p}_{5} & {p}_{6} \\ {p}_{7} & {p}_{8}\end{matrix} ] , \qquad ( 1 )$$

Where pᵢ is the +1 or −1 phase for Part i in FIG. 4. Two equivalent transformations are observed. The first one is a global phase change for each column of Equation (1):

$${P}_{1} = [ \begin{matrix}{p}_{1} & {p}_{2} \\ {p}_{3} & {p}_{4} \\ {p}_{5} & {p}_{6} \\ {p}_{7} & {p}_{8}\end{matrix} ] [ \begin{matrix}{e}^{j α} & 0 \\ 0 & {e}^{j β}\end{matrix} ] ,$$

Where α and β are the phases applied to columns 1 and 2, i.e., the first and second halves of the RU52, respectively. The phases of α and β take the angles between the data constellation points, e.g., {0, 180} degrees for BPSK and {0, 90, 180, 270} degrees for QPSK. With these angles, after the global phase rotations are applied, the data symbols will still stay in the same constellation.

Because the transmitted data corresponding to each column is the same and the data for different OFDM symbols are uniformly and independently distributed, global phases don't change the joint distribution of the data symbols per OFDM symbol. Therefore, P and P₁ have the same PAPR performance. Taking α=π or 180 degrees, and β=0, it is possible to convert the solution.

The second equivalent transformation is:

$${P}_{2} = [ \begin{matrix}{p}_{5} & {p}_{6} \\ {p}_{7} & {p}_{8} \\ {p}_{1} & {p}_{2} \\ {p}_{3} & {p}_{4}\end{matrix} ] . \qquad ( 3 )$$

In FIG. 3 and FIG. 4, the left half and the right half of the band have the same structure and the same distance to the DC subcarrier. Note that P₂ in Equation (3) is a row-wise cyclic shift of P in Equation (1). The PAPR distribution remains the same. Applying transformation (3) to solution MTK in FIG. 4, solution QCM is reached. Therefore, all three solutions are equivalent.

Using the two transformations (2) and (3) jointly or individually, it is possible to generate many equivalent mask matrixes. For example,

$$[ \begin{matrix}- 1 & - 1 \\ 1 & 1 \\ 1 & - 1 \\ 1 & - 1\end{matrix} ] and [ \begin{matrix}1 & - 1 \\ 1 & - 1 \\ - 1 & - 1 \\ 1 & 1\end{matrix} ]$$

are solutions equivalent to the ones in FIG. 4. It could be possible to further relax the constrains on the ranges of α and β for further reducing the PAPR. For example, it is possible to allow the α and β take values from {0, 90, 180, 270} degrees also for BPSK instead of QPSK.

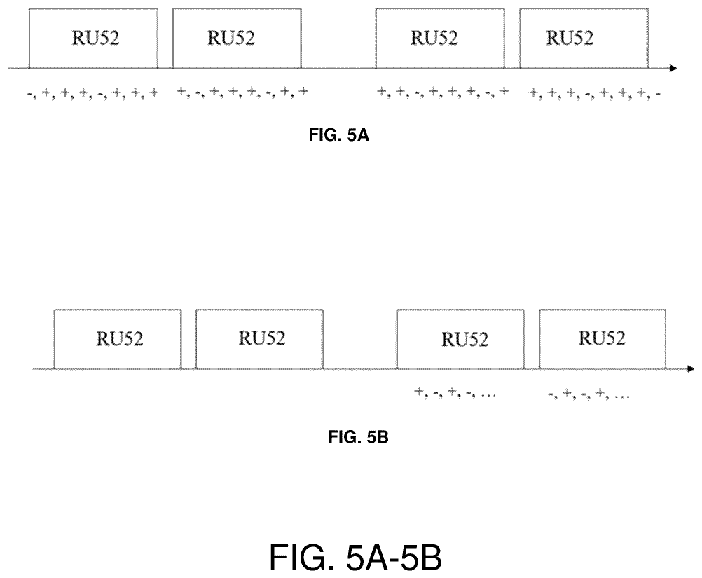

A proposed solution is different as illustrated in FIG. 5A. Instead of a common masking BPSK symbol for each part, each subcarrier has its masking BPSK symbol. For each 52-tone-RU, a length-4 BPSK sequence is repeatedly masked with the symbol on each subcarrier in each 52-tone-RU. Specifically, [−1 1 1 1] is repeated 13 times and then the length-52 BPSK sequence is masked with the 52 symbols on the first 52-tone-RU, respectively; [1 −1 1 1] is repeated 13 times and then the length-52 BPSK sequence is masked with the 52 symbols on the second 52-tone-RU, respectively; [1 1 −1 1] is repeated 13 times and then the length-52 BPSK sequence is masked with the 52 symbols on the third 52-tone-RU, respectively; [1 1 1 −1] is repeated 13 times and then the length-52 BPSK sequence is masked with the 52 symbols on the fourth 52-tone-RU, respectively. The four length-4 BPSK sequences forms 4 by 4 circulant matrix:

$$[ \begin{matrix}- 1 & 1 & 1 & 1 \\ 1 & - 1 & 1 & 1 \\ 1 & 1 & - 1 & 1 \\ 1 & 1 & 1 & - 1\end{matrix} ] . \qquad ( 4 )$$

A proposed solution in this disclosure is illustrated in FIG. 5B. It is similar to the BRM solution, but it is simpler. The main difference is that length-2 BPSK sequences are used instead of length-4 BPSK circulant sequences. This not only reduces the implementation complexity but also reduces the PAPR. There are a few length-2 BPSK sequences with good performances. The best one is illustrated in FIG. 5B. No phase masking is applied to the first two 52-tone-RUs for low complexity. For the third 52-tone-RU, the symbols on the even subcarriers are masked by −1. Namely, data symbol phases on subcarriers 2, 4, . . . , 52 get flipped. For the fourth 52-tone-RU, the symbols on the odd subcarriers are masked by −1. Namely, data symbol phases on subcarriers 1, 3, . . . , 51 get flipped.

Using the notation BPSK masking matrix

$$M = [ \begin{matrix}1 & 1 \\ 1 & 1 \\ 1 & - 1 \\ - 1 & 1\end{matrix} ]$$

was proposed, where the masking BPSK sequence of the i-th 52-tone-RU is formed by repeating the i-th row of M by 26 times. Some BPSK masking matrices are equivalent in terms of PAPR performance. For example, M, −M, and e^{jØ}M have the same PAPR performance, where Ø is an angle. For another example, M and \tilde{M} have the same PAPR performance, where \tilde{M} consists of the rows of M in a reverse order. For a third example, M and

$$M [ \begin{matrix}{e}^{j {∅}_{1}} & 0 \\ 0 & {e}^{j {∅}_{2}}\end{matrix} ]$$

have the same performance, where Ø₁ and Ø₂ are angles, Øᵢ=−1 or 1 for BPSK ELR data,

$${∅}_{i} = \frac{k π}{2}$$

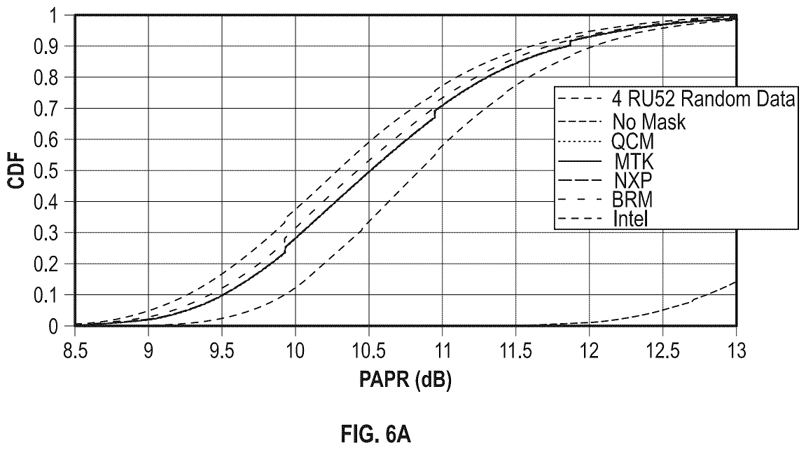

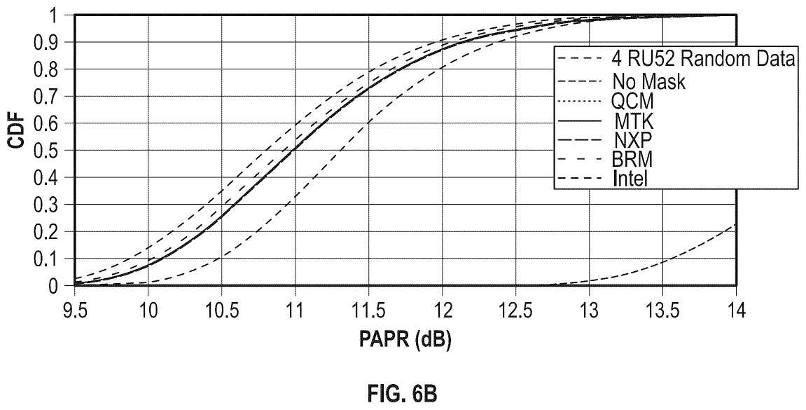

for QPSK ELR data, for i=1,2 and k=0,1,2,3. The example of M in FIG. 6 only has two −1s such that phase flipping operations are minimized. Other examples of M, which have more −1s, e.g., four −1s, and about the same PAPR performances, are

$$M = [ \begin{matrix}1 & 1 \\ - 1 & - 1 \\ - 1 & 1 \\ - 1 & 1\end{matrix} ] and M = [ \begin{matrix}1 & - 1 \\ 1 & - 1 \\ - 1 & - 1 \\ 1 & 1\end{matrix} ] ,$$

which can be converted to the M in FIG. 5B by equivalence operations like column-wise phase rotation and row order reversal mentioned above. For a fourth example, the row-wise shift in (3), i.e., shifting two rows, also generates equivalent matrixes. Same or similar transformations can be applied to BRM's length-4 mask matrix (4) to get equivalent mask sequences.

In recent discussions, some companies agreed that the pilot signals in each RU52 should not be changed by the phase masking. Without this constraint,

$$[ \begin{matrix}- 1 & 1 \\ 1 & - 1 \\ 1 & 1 \\ 1 & 1\end{matrix} ] , [ \begin{matrix}1 & - 1 \\ - 1 & 1 \\ 1 & 1 \\ 1 & 1\end{matrix} ] ,$$

$$[ \begin{matrix}1 & 1 \\ 1 & 1 \\ - 1 & 1 \\ 1 & - 1\end{matrix} ] , [ \begin{matrix}1 & 1 \\ 1 & 1 \\ 1 & - 1 \\ - 1 & 1\end{matrix} ]$$

and their equivalent ones have the same PAPR performance. However, with the pilot constraint, the results changed. Note that the pilots are on the even subcarriers and there is one null subcarrier between the 1^{st} and 2^{nd} RU52s and between the 3^{rd} RU52 and 4^{th} RU52. The phase masking of

$$[ \begin{matrix}- 1 & 1 \\ 1 & - 1 \\ 1 & 1 \\ 1 & 1\end{matrix} ] and [ \begin{matrix}1 & 1 \\ 1 & 1 \\ - 1 & 1 \\ 1 & - 1\end{matrix} ]$$

don't affect the pilot subcarriers and have the best PAPR performance. Namely, the polarity flipping does not happen on even subcarriers. Therefore, they and their equivalent versions with column-wise global phase rotations or/and cyclic two-row shifting are desirable. The cyclic one-and three-row shifting of

$$[ \begin{matrix}- 1 & 1 \\ 1 & - 1 \\ 1 & 1 \\ 1 & 1\end{matrix} ] and [ \begin{matrix}1 & 1 \\ 1 & 1 \\ - 1 & 1 \\ 1 & - 1\end{matrix} ]$$

and their equivalent versions with column-wise global phase rotations have slightly worse PAPR performance.

The PAPR performances of the proposed solution are denoted by “Intel” in FIG. 6A and 6B for BPSK ELR data and QPSK ELR data, respectively. The proposed solution provides about 4 dB PAPR reduction over the straightforward 4× duplication without phase masking. Compared to the PAPR of fully independent, random data transmission on the four 52-tone-RUs, the proposed solution has about 0.6 dB gain. Finally, the proposed solution outperforms all other schemes proposed by the other companies consistently over all CDF percentiles for both BPSK and QPSK ELR data transmissions. In the figures, the performances of solutions QCM, MTK and NXP are almost exactly the same. BRM's length-4 scheme outperforms the three and Intel's length-2 scheme outperforms the other four, e.g., better than the three by 0.2-0.25 dB at CDF 50 percentile.

Because it is possible to generate a length-4 sequence by repeating a length-2 sequence, length-2 sequences are a subset of length-4 sequences. In theory, length-4 sequences should have better performance than length-2 sequences at the cost of implementation complexity. However, BRM's length-4 sequences, which are circulant, are not a good choice as shown in FIGS. 6A and 6B. It is likely that to find a set of sequences with a length greater than 2 have better performance than the length-2 sequences found.

In one embodiment, for backward compatibility, the phase masking may be applied to the pilot subcarriers of the RUs such that the PAPR may be reduced a little bit.

Band Edge Augmentation for Power Boosting:

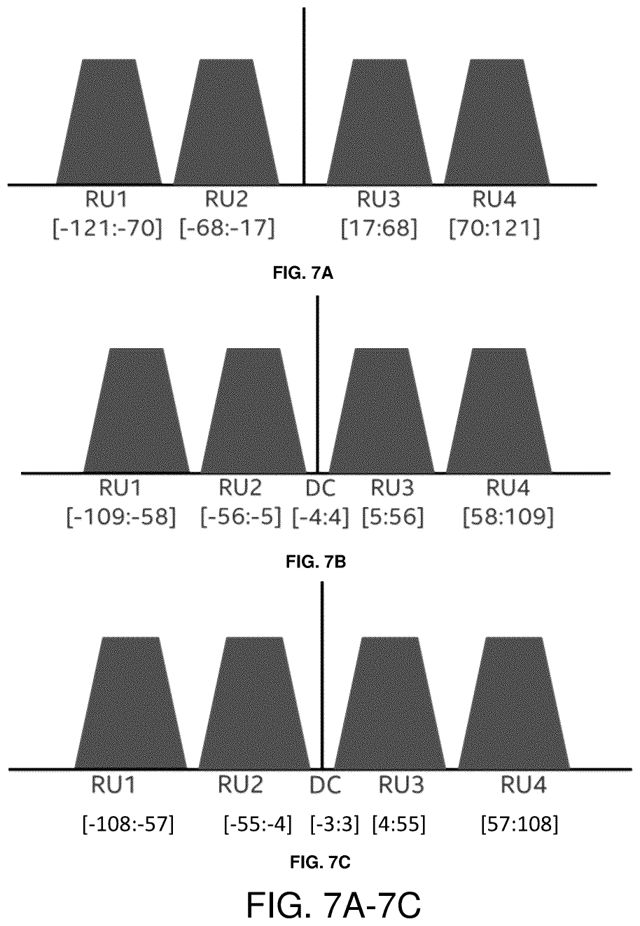

RRU52 with four times duplication in frequency domain in 20 MHz may be used for ELR-DATA transmission with the center RRU26 being empty as illustrated in FIG. 7A. The pilots are at subcarriers {−116, −102, −90, −76}, {−62, −48, −36, −22}, {22, 36, 48, 62}, and {76, 90, 102, 116} for the four RR52s, respectively.

To mitigate the out of band emissions, it was proposed to shift the four RRU52 close to the DC tones in AG2467 as shown in FIG. 7B. However, a typo was made in the pilot subcarrier indexes. Here is the correction. The pilots should be on even subcarriers to support ELR-LTF symbol with 2× symbol duration (2× ELR-LTF) because only even subcarriers are active in 2× ELR-LTF. If ELR-LTF symbol with 4× symbol duration (4× ELR-LTF) is used, the pilots don't need to be on the even subcarriers and the original design is fine.

Option 1: Shift all four Regular RU52s (RRU52s) close to the DC tones by 12 tones as shown below with the pilot tones on even subcarriers as: {−104 −90 −78 −64}, {−50 −36 −24 −10}, {10 24 36 50}, {64 78 90 104}.

Option 2: Shift all of the four RRU52 close to the DC tones by 13 tones as shown in FIG. 7C with the pilot tones on even subcarriers as: {−102 −88 −76 −62}, {−50 −36 −24 −10}, {10 24 36 50}, {62 76 88 102}. It should be noticed that there are two patterns for the relative locations of the 4 pilots within the RUs in FIG. 7C. The structures of RU1 and RU3 are the same. The structures of RU2 and RU4 are the same. In Option 1, the relative locations of the pilots within each RU are the same as FIG. 7C. In Option 2, the two patterns are reused by different RUs. Namely, RU1 and RU3 in Option 2 reuse the relative pilot locations of RU2 and RU4 in FIG. 7C. RU2 and RU4 in Option 2 reuse the relative pilot locations of RU1 and RU3 in FIG. 7C.

### Low-PAPR Sequences for BSS Color Indication:

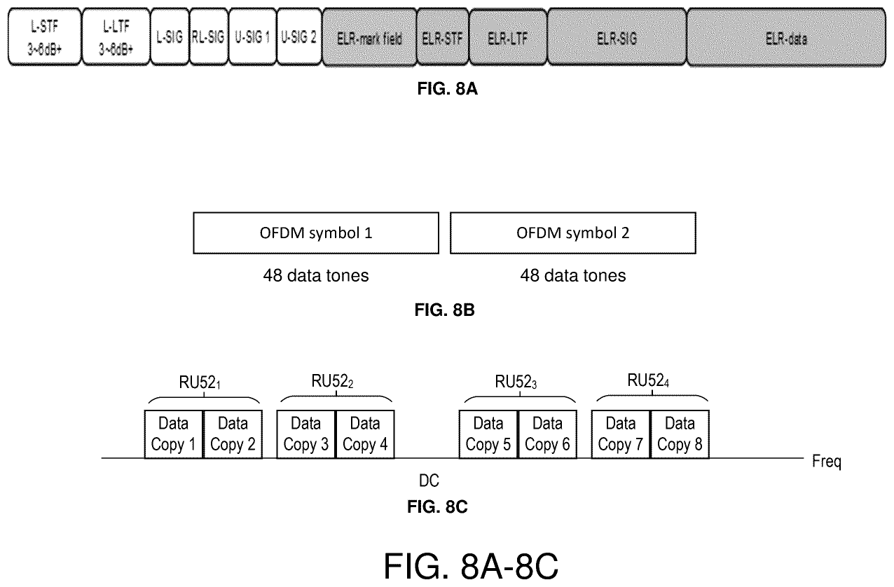

There is an ELR-Mark field in ELR PPDU as shown in FIG. 8A. Ideas were proposed to reduce the PAPR of the ELR-Mark, which carries different sequences in frequency domain to signal BSS colors, respectively. Additional details of the design in this disclosure are provided.

The ELR-Mark field may consist of two OFDM symbols each with 1× symbol duration. There are 64 BSS colors, which require 64 sequences. Each sequence consists of two subsequences, one on each OFDM symbol with 48 data subcarriers each as shown in FIG. 8B. The sequence length is 2×48=96. Therefore, there is a need 128 subsequences whose length is 48. Other companies proposed to use orthogonal sequences with low PAPRs. It is noticed that the orthogonality is unnecessary. The problem can be formulated as a sphere packing problem in 96-dimension linear space. The aim is to find 64 sequences with low PAPRs and a maximized minimum separation.

$${min}_{i \neq j , i , j ∈ \{ 1 , 2 , … , 64 \}} max ( 〈 {S}_{i} , {S}_{j} 〉 ) , \qquad ( 5 )$$

where Sₖ is the k-th sequence, and [symbol] Sᵢ, Sⱼ [symbol] is the inner product of the two sequences and the greater the value the smaller the separation, the dimension of Sₖ is 96 (or 104), each of the 96 elements of Sₖ takes values from {1, −1} or {1, −1, j, −j}. Orthogonal sequences don't maximize the separation. Namely, the sequence set should contain non-orthogonal sequences or subsequences.

It is hard to find 128 subsequences with low PAPRs. As described in AG1819 and AG2467, it is possible to have the following methods to construct low-PAPR sequences or subsequences: 1) CSD cyclic shift in time domain or linear phase roll in frequency domain of the subsequence, 2) sequence/subsequence reversion in time domain or frequency domain, and 3) phase rotation of the whole sequence/subsequence. In addition, it is possible to cyclically shift a low-PAPR sequence or subsequence in frequency domain to generate additional low-PAPR sequence or subsequence. Unlike linear phase roll in frequency domain, the cyclic shift in frequency domain is of low complexity. Because the subsequence or sequence cannot use the DC, edge, and pilot subcarriers, it is possible to cyclically shift a length-48 sequence like L-LTF sequence with the 4 pilot subcarriers removed or punctured. Alternatively, it is possible to generate a low-PAPR, length-64 sequence, cyclically shift it, and then remove the elements corresponding to the DC, edge, and pilot subcarriers, getting length-48 subsequences. Because most of the linear phase rolls in frequency domain incurs complexities, it is possible to only use the linear phase rolls with low complexities. For example, linear phase rolls [0 0 0 0 . . . ] degrees, [0 90 180 270 0 90180 270 . . . ] degrees, [0 180 0 180 . . . ] degrees, and [0 270 180 90 0 270 180 90 . . . ] degrees, which correspond to multiplying the input sequence with mask sequences [1 1 1 1 . . . ], [1 j −1 −j 1 j −1 −j . . . ], [1 −1 1 −1 . . . ], and [1 −j −1 j 1 −j −1 j . . . ], respectively. Besides the linear phase roll sequences, other mask sequences taking values from {1, −1} or {1, −1, j, −j} may be used for low complexity at small costs of PAPR increases. The global phase rotation of the whole sequence/subsequence preserves the PAPR. In addition, the global phase rotation of polarity flip, i.e., multiplying the sequence/subsequence with −1 maximizes the separation. Furthermore, the global phase rotation of multiplying j or −j achieves the separation between two orthogonal sequences/subsequences with higher reliability in fading channels.

In FIG. 8B, the two length-48 subsequences in the two OFDM symbols can be the same for low complexity at the cost of negligible performance degradation. Namely, repeat the subsequence to generate the sequence. The two subsequences can be different for diversity gain in fading channels. For example, the second subsequence can be a reversion, or another permutation, or a time domain shifted version, or a frequency domain shifted version, or a global phase rotation of the first. Namely, concatenate two different subsequences to generate a sequence. Although it is possible to maximize the separation by searching for low-PAPR length-96 sequences directly instead of using repetition/concatenation, the complexity is high.

Use these methods to construct 64 sequences. First, construct the subsequences and then generate the sequences by repetition and/or concatenation as mentioned above.

### Example 1

16 base subsequences and 4 global phase rotations.

First get 16 low-PAPR sequences with good separation, e.g., 16 orthogonal or quasi-orthogonal sequences. For example, use a low-PAPR subsequence like L-LTF sequence to generate 16 low-PAPR subsequences by CSD shifts with 4 n time-domain samples or linear phase rolls with phase increment π/8n for n=0,1, . . . ,15. After generating the subsequences, 4 global phase rotations {1, −1, j, −j} can be applied to the generated subsequences to generate 64 subsequences.

### Example 2

16 base subsequences and 4 global phase rotations.

First get 16 low-PAPR sequences with good separation, e.g., 16 orthogonal or quasi-orthogonal sequences. For example, use a low-PAPR subsequence like L-LTF sequence to generate 16 low-PAPR subsequences with good separations (e.g., small inner products) by cyclic shifts in frequency domain. After generating the subsequences, 4 global phase rotations {1, −1, j, −j} can be applied to generate 64 subsequences.

### Example 3

16 base subsequences, 2 global phase rotations, and reversion.

First get 16 low-PAPR sequences with good separation, e.g., 16 orthogonal or quasi-orthogonal sequences. For example, use a low-PAPR subsequence like L-LTF sequence to generate 16 low-PAPR subsequences with good separations (e.g., small inner products) by cyclic shifts in frequency or time domain. After generating the subsequences, 2 global phase rotations {1, −1} can be applied to generate 32 subsequences. The 32 subsequences can be reversed to generate another 32 subsequences.

### Example 4

2 base subsequences, 4 linear phase rolls, 4 global phase rotations, and reversion.

First get 2 low-PAPR sequences with good separation, e.g., 2 orthogonal or quasi-orthogonal sequences. For example, use a low-PAPR subsequence like L-LTF sequence and search for another sequence to generate 2 low-PAPR subsequences with good separations (e.g., small inner products). By 4 low-complexity linear phase rolls with mask sequences [1 1 1 1 . . . ], [1 j −1 −j 1 j −1 −j . . . ], [1 −1 1 −1 . . . ], and [1 −j −1 j 1 −j −1 j . . . ] in frequency domain, there is 8 subsequences with low PAPRs. Then, 4 global phase rotations {1, −1, j, −j} can be applied to generate 32subsequences. The 32 subsequences can be reversed to generate another 32 subsequences.

In general, for a given subsequence number like 64 or 32, there are many combinations of the numbers of base subsequences, linear phase rolls, frequency-domain shifts, global phase rotations, and reversion.

Diversity Enhancement for Lowest Data Rate:

For the lowest data rate, it is proposed here to use QPSK with code rate ½ and 8 signal repetitions instead of the existing BPSK with code rate ½ and 4 signal repetitions as illustrated in FIG. 8C. The more the repetitions the higher the diversity gain.

There is a need for a set of MAC rules in order to regulate the usage of ELR PPDUs by STAs and APs.

A STA shall not transmit an ELR PPDU to a peer STA if the peer STA doesn't support ELR PPDU reception.

An AP shall not transmit an ELR PPDU in the 5 GHz and 6 GHz bands.

A UHR STA shall send Control frames following the rules defined in 10.6.6 (Rate selection for Control frames) with the following exceptions:
A Control frame sent by a UHR STA as a response to an ELR PPDU that does not contain a triggering frame (or that contains a BSRP trigger frame that solicits a response in non-Trigger Based PPDU) should be carried in an ELR PPDU, unless the most recent PPDU sent by the UHR STA to the recipient of the Control frame, after association, was not an ELR PPDU. In this case, the Control frame should be carried in a non-HT PPDU.
A Control frame sent by a UHR STA as a response to an SU PPDU or a non-HT PPDU that does not contain a triggering frame (or that contains a BSRP trigger frame that solicits a response in non-TB PPDU) should be carried in a non-HT PPDU, unless the most recent PPDU sent by the UHR STA to the recipient of the Control frame, after association, was an ELR PPDU. In this case, the Control frame should be carried in an ELR PPDU.
A control response frame shall not be sent in an ELR PPDU if the channel bandwidth of the PPDU containing the frame that elicited the response is greater than 20 MHz.
A Control frame that is not solicited by another frame and is not a Trigger frame may be carried in an HE ER SU PPDU.

A UHR STA shall follow the rules defined in 10.6 (Multirate support) for selecting the rate, MCS, and NSS and the rules defined in 10.3.2.7 (VHT and SIG RTS procedure), 10.3.2.9 (CTS and DMG CTS procedure), 10.6.6 (Rate selection for Control frames), and 10.6.12 (Channel Width in non-HT and non-HT duplicate PPDUs) for selecting the channel width (BW) of transmitted PPDUs with the following exceptions:
A STA that transmits a Control frame carried in a non-HT PPDU that is a response to a frame received in an ELR PPDU shall/should set the rate of the non-HT PPDU to 6 Mb/s

It was agreed to define a new field in the BSRP trigger frame to determine what PPDU type is solicited by the trigger frame:
(1) The PPDU type can be TB PPDU, as currently defined in regular BSRP trigger frames.
(2) Non-HT (Dup) PPDU.

It is proposed that when the BSRP trigger frame is soliciting a response with the PPDU format (2), then the response may be either non-HT (duplicate) PPDU or ELR PPDU. The new field would then be set to 1 to indicate that the response shall be either in non-HT (duplicate) PPDU or ELR PPDU.

It is proposed also that the ELR PPDU can be an ELR (duplicate) PPDU, by duplicating the ELR PPDU constructed on 20 MHz over the TxOP/PPDU BW or over the allocation/BW given to the STA with the BSRP trigger frame for a PPDU sent in response to a BSRP Trigger frame not soliciting TB PPDU.

It is understood that the above descriptions are for the purposes of illustration and are not meant to be limiting.

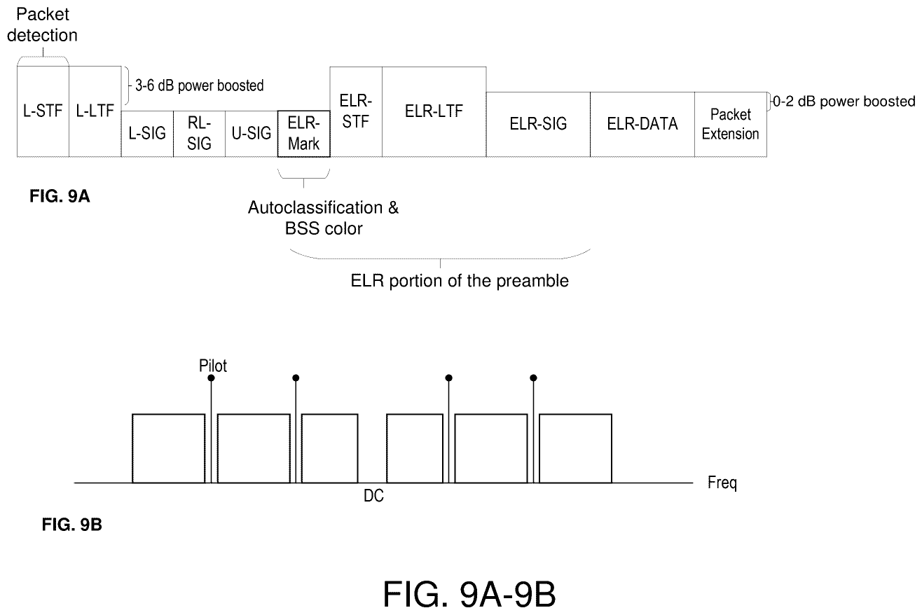

FIGS. 9A-9B depict illustrative schematic diagrams for ELR preamble, in accordance with one or more example embodiments of the present disclosure.

### Power Boosting of Pilots:

The PPDU format of enhanced long-range mode (ELR) is shown in FIG. 9A. The powers of L-STF and L-LTF are boosted by 3-6 dB for enhancing the packet detection and channel estimation. The transmit power of L-SIG, RL-SIG, and U-SIG is not boosted because of the high PAPR caused by the random data in these fields.

In the four OFDM symbols of L-SIG, RL-SIG, and U-SIG, there are four pilots per OFDM symbol. The receiver uses the pilot signals to estimate the carrier frequency offset (CFO) and correct the CFO. The CFO estimation requires the knowledge about the SNR of the pilot signals. For example, if the SNR is low, the CFO estimation may use a larger moving average window for reducing the estimation error at the cost of a slower convergence. In contrast, if the SNR is high, the CFO estimation may be a smaller moving average window for fast convergence.

The SNR of the pilot is estimated from L-LTF. Different from non-ELR PPDU, there is a power drop between L-LTF and the next four OFDM symbols as illustrated in FIG. 9A. If the receiver knows the power drop of ELR PPDU, the receiver can update the pilot SNR estimated from the L-LTF by reducing the SNR estimate by 3-6 dB. However, when receiving an ELR PPDU, the receiver does not know whether the PPDU is of ELR type or not until U-SIG is decoded or ELR-Mark field is decoded. Furthermore, it is hard and unreliable for receiver to detect the power drop between L-LTF and L-SIG. The reason is that the received signal powers of L-SIG, RL-SIG, U-SIG fluctuate with the information bits carried in them and the noise power dominates the received signal power in the operating SNR region of ELR. Therefore, for ELR PPDU, using the L-LTF, the receiver overestimates the SNR of the pilots and degrades the CFO estimation. As a result, the decoding of L-SIG, RL-SIG, U-SIG, and ELR-Mark gets degraded. In addition, the degraded CFO estimation may affect the subsequent decoding of ELR-SIG and ELR-Data.

A solution is proposed as follows. It is proposed to boost the power of the pilot signals in L-SIG, RL-SIG, U-SIG as illustrated in FIG. 9B. As a result, for both ELR and non-ELR PPDU, the receiver can reuse the pilot process developed for the existing, non-ELR PPDU. The pilot power can be boosted to the same level as the preceding L-LTF, e.g., increased by 3-6 dB. Because there are only four pilots in each OFDM symbol, the 3-6 dB power boost of the pilots has a negligible impact to the data subcarriers, i.e., reducing the data power by 0.59-0.90 dB.

11ac-Based Rate Matching and its Indication:

The rate matching is to determine the parameters like the number of OFDM symbols (and the number and the block size of the LDPC codewords) for a given payload size, the number of streams, bandwidth, and MCS. IEEE 802.11ac-based rate matching is used by 802.11ac/ax/bc. The logic flow is roughly as follows. The LENGTH field in the L-SIG (and another field like PE-Disambiguity field) mainly determines the number of OFDM symbols in the PPDU. The a-factor in the preamble determines the PHY payload size for the codebits (or the PHY boundary in the last OFDM symbol). For ELR, there is no need for a-factor because the payload size of each OFDM symbol is small, e.g., 48 or 96 codebits, i.e., 24 or 48 information bits. The LDPC extra symbol (segment) field determines the MAC payload size. The receiver first determines the PHY payload size and then determines the MAC payload size. Based on the PHY payload size, the block sizes and the number of LDPC codes are determined. These coding parameters then determine the puncturing, shortening, and repetition of each LDPC codeword. In AG2887, a 11ac-based rate matching scheme is proposed. Because the packet extension can be a fixed duration for ELR, there is no need for PE-Disambiguity field in the ELR-SIG. For preventing over puncturing and over shortening of the LDPC codewords, the LDPC extra symbol (segment) field is needed in ELR-SIG. The indication of the proposed rate matching scheme, i.e., ELR-SIG field, is illustrated in Table 7. The LENGTH field may indicate the number of data OFDM symbols in the ELR PPDU. Because each OFDM carries 3 and 6 information bytes for BPSK and QPSK, respectively, the unit of the LENGTH field can be either OFDM symbol or N (information) bytes, where N=1,2,3,4,6, . . . . The LDPC extra symbol field indicates whether one additional resource block, which may be one or multiple (like 2, 4, 8) OFDM symbol(s), is added to the PPDU to reduce the puncturing or shortening of LPDC codewords. An OFDM symbol segment is not big enough to reduce the puncturing or shortening effectively. The size of the additional resource block can be constant like 2 OFDM symbols or can be proportional to the LDPC codeword size like

$$⌊ \frac{{N}_{LDPC} \cdot a \%}{{N}_{CBPS}} ⌋$$

OFDM symbols, where N_{LDPC} is the block size of the LDPC codeword, N_{CBPS} is the number of codebits carried by each OFDM symbol.

$$⌊ \frac{{N}_{LDPC} \cdot a \%}{{N}_{CBPS}} ⌋$$

is the required number of OFDM symbols that can carry a % like 10% of one LDPC codeword.

In Table 7, MCS and coding fields are in the first OFDM symbol of ELR-SIG, denoted by ELR-SIG-1. This allows the receiver to configure the decoder early. The coding field can be one bit or two bits. If only BCC and the legacy LDPC are supported, one bit is enough. If BCC, legacy LDPC, and 2× lifted LDPC are supported, then two bits are needed for the coding field. In one embodiment, part of or the entire LENGTH field may be in the second OFDM symbol of ELR-SIG, denoted by ELR-SIG-2. Similarly, part of or the entire AID field may be in the first OFDM symbol of ELR-SIG. In another embodiment, TXOP duration may be included in ELR-SIG. For example, at least part of the TXOP indication bits is in the second OFDM symbol of ELR-SIG. In a third embodiment, More ELR-PPDU field may not be included in the ELR-SIG. In a fourth embodiment, the CRC and/or tail in the first OFDM symbol may not be included in the ELR-SIG.

TABLE 7

| | | | | | | | B14- | B18- |
|---|---|---|---|---|---|---|---|---|
| | B0 | B1 | B2 | B3 | B4-B12 | B13 | B17 | B23 |
| ELR- | ELR- | DL/UL | MCS | Coding | LENGTH | LDPC | CRC | Tail |
| SIG-1 | version | | | | | extra | | |
| | | | | | | symbol | | |

| | | | | B14- | B18- |
|---|---|---|---|---|---|
| | B0-B10 | B11 | B12-B13 | B17 | B23 |
| ELR- | AID | More ELR- | Reserved | CRC | Tail |
| SIG-2 | | PPDU | | | |

For reducing the puncturing, the LDPC extra symbol field may use multiple bits like 2 bits. For example, 00 indicates no LDPC extra resource block, 01 indicates one LDPC extra resource block, 10 indicates two LDPC extra resource blocks, and 11 indicates three LDPC extra resource blocks. One resource block may be one or multiple OFDM symbols.

11n-Based Rate Matching and its Indication:

Because the TXOP duration is limited to 5 ms and the highest data rate of ELR is about 3.3 mbps, the maximum number of bytes can be carried in one PPDU is roughly 2000 bytes, which can be indicated by 11 bits. In 802.11n, the number of payload bytes is indicated in HT-SIG using 16 bits. The big advantage of 11n-based rate matching is that the LDPC extra symbol (segment) field is not needed. Using the payload size together with other parameters like the number of streams, bandwidth, and MCS, the receiver can determine the number of OFDM symbols and the LDPC extra symbol (segment) in the same way as the transmitter. Because Wi-Fi devices are backward compatible, the 802.11n mode needs to be supported in UHR devices. Therefore, there is no cost to reuse the 11n-based rate matching in ELR of UHR.

The process of 11n-based rate matching is outlined as follows. The process is used by both the transmitter and receiver to determine the details of each LDPC codewords. The LENGTH field in ELR-SIG indicates the payload size in the unit of N (information) bytes, e.g., 1, 2, 3, 4, 6 bytes, or in the unit of the information payload size of M OFDM symbols. For example, the information payload size of 1, 2, 3, 4 OFDM symbols is 3, 6, 9, 12 bytes for BPSK and 6, 12, 18, 24 bytes for QPSK, respectively. Instead of a constant unit for the LENGTH field, the unit can vary with the modulation order specified in the MCS field of ELR-SIG. For example, the unit is 3 and 6 bytes for BPSK and QPSK, respectively.

Using the payload size in bit N_{PLD} and N_{CBPS} that is the number of codebits carried by each OFDM symbol, determine the minimum number of OFDM symbols denoted by N_{SYM}. The value in the LENGTH field of ELR-SIG is proportional to N_{PLD}.

Using N_{CBPS} and N_{SYM}, determine the total number of codebits carried by the PPDU denoted by N_{TCB}.

Using N_{TCB}, determine the LDPC codeword size N_{LDPC}.

Using the numbers above, determine the number of shortening bits per LDPC codeword.

Generate the parity bits.

Pack the codebits into N_{SYM} symbols.

If the condition of over puncturing or over shortening is met, one additional resource block is added to the PPDU. The size of the additional resource block can be constant like 2 OFDM symbols or can be variable. For example, the additional resource block size is proportional to the LDPC codeword size like

$$⌊ \frac{{N}_{LDPC} \cdot a \%}{{N}_{CBPS}} ⌋$$

OFUM symbols, where N_{LDPC} is the block size of the LDPC codeword, N_{CBPS} is the number of codebits carried by each OFDM symbol,

$$⌊ \frac{{N}_{LDPC} \cdot a \%}{{N}_{CBPS}} ⌋$$

is the required number of OFDM symbols that can carry a % like 10% of one LDPC codeword. For another example, the additional resource block size depends on the level of over puncturing and over shortening. The additional resource block may be the smallest number of OFDM symbols that are just enough to mitigate the over puncturing and/or over shortening, e.g., meeting the conditions in Equation (19-38) in IEEE 802.11me specification.

Conduct puncturing and repetition to fill the OFDM symbols of the PPDU.

An example of the ELR-SIG for 11n-base rate matching is illustrated in Table 8. The LDPC extra symbol field is not needed because both the transmitter and receiver can figure out whether an extra resource block is added to the PPDU using the LENGTH field and other fields in the ELR-SIG.

TABLE 8

| | | | | | | B14- | B18- |
|---|---|---|---|---|---|---|---|
| | B0 | B1 | B2 | B3 | B4-B13 | B17 | B23 |
| ELR- | ELR- | DL/UL | MCS | Coding | LENGTH | CRC | Tail |
| SIG-1 | version | | | | | | |

| | | | | B14- | B18- |
|---|---|---|---|---|---|
| | B0-B10 | B11 | B12-B13 | B17 | B23 |
| ELR- | AID | More ELR- | Reserved | CRC | Tail |
| SIG-2 | | PPDU | | | |

In Table 8, MCS and coding fields are in the first OFDM symbol of ELR-SIG, denoted by ELR-SIG-1. This allows the receiver to configure the decoder early. The coding field can be one bit or two bits. If only BCC and the legacy LDPC are supported, one bit is enough. If BCC, legacy LDPC, and 2× lifted LDPC are supported, then two bits are needed for the coding field. In one embodiment, part of or the entire LENGTH field may be in the second OFDM symbol of ELR-SIG, denoted by ELR-SIG-2. Similarly, part of or the entire AID field may be in the first OFDM symbol of ELR-SIG. In another embodiment, TXOP duration may be included in ELR-SIG. For example, at least part of the TXOP indication bits are in the second OFDM symbol of ELR-SIG. In a third embodiment, More ELR-PPDU field may not be included in the ELR-SIG. In a fourth embodiment, the CRC and/or tail in the first OFDM symbol may not be included in the ELR-SIG.

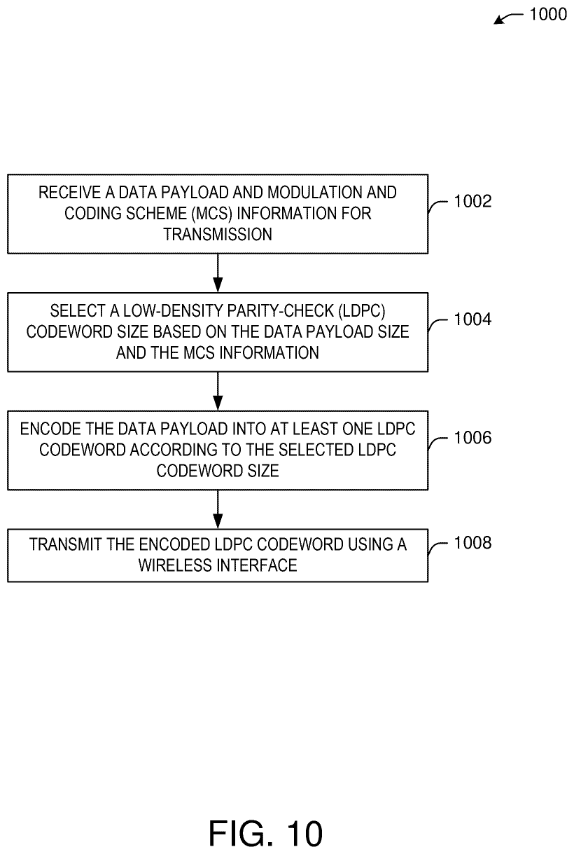

FIG. 10 illustrates a flow of illustrative process 1000 for an enhanced connectivity system, in accordance with one or more example embodiments of the present disclosure.

At block XY02, a device (e.g., the user device(s) XX20 and/or the AP XX02 of FIG. XX and/or the optimized beacon delivery device ZZ19 of FIG. ZZ) may receive a data payload and modulation and coding scheme (MCS) information for transmission.

At block XY04, the device may select a low-density parity-check (LDPC) codeword size based on the data payload size and the MCS information.

At block XY06, the device may encode the data payload into at least one LDPC codeword according to the selected LDPC codeword size.

At block XY08, the device may transmit the encoded LDPC codeword using a wireless interface.

In one or more embodiments, the device may receive a data payload along with MCS information intended for transmission. The device may select an LDPC codeword size based on the size of the data payload and the received MCS information, providing a flexible approach to accommodate different data rates and channel conditions. By encoding the data payload into at least one LDPC codeword according to the selected size, the device may enhance transmission reliability and efficiency. For instance, when the payload size is smaller than a certain threshold for a given MCS, the device may add padding, potentially consisting of one or more OFDM symbols. This approach may ensure the encoded block aligns with modulation boundaries, reducing wasted bandwidth.

In addressing the need for adaptability, the device may select the LDPC codeword size from a set of predetermined codeword lengths, such as 648 bits, 1296 bits, or 1944 bits. For example, a larger payload might benefit from the 1944-bit length, while a smaller payload could use 648 bits, thereby optimizing the trade-off between error correction and overhead. The device may also determine the amount of pre-FEC padding required based on both the payload and MCS information before the encoding takes place, allowing for more efficient use of available transmission resources.

To further enhance system transparency, the device may indicate, within a signal field, the number of extra OFDM symbols added for LDPC padding. This information may be critical for a receiver to correctly reconstruct the original data. For example, the device may use a fixed padding factor that concludes at an OFDM symbol boundary, thereby ensuring clean alignment and reducing potential decoding errors.

Moreover, in one or more embodiments, the device may select the number of LDPC extra symbol segments by comparing puncturing and shortening ratios to predetermined thresholds. As an example, if the shortening ratio exceeds a certain value, the device may allocate additional symbols to maintain codeword integrity. The device may also transmit the encoded LDPC codeword using a wireless interface selected from various frequency channels, including 2.4 GHz, 5 GHz, 6 GHz, or 60 GHz, thereby offering flexibility to operate in diverse radio environments and address congestion or regulatory constraints.

Finally, the device may indicate an ELR PPDU type in a universal signal field, enabling the system to communicate extended range capabilities. This solution may address the challenge of ensuring robust communication over longer distances or in more challenging propagation conditions. By employing these strategies, the device may offer a versatile, adaptive, and efficient wireless transmission solution tailored to the needs of modern communication systems.

It is understood that the above descriptions are for the purposes of illustration and are not meant to be limiting.

FIG. 11 shows a functional diagram of an exemplary communication station 1100, in accordance with one or more example embodiments of the present disclosure. In one embodiment, FIG. 11 illustrates a functional block diagram of a communication station that may be suitable for use as an AP 102 (FIG. 1) or a user device 120 (FIG. 1) in accordance with some embodiments. The communication station 1100 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 1100 may include communications circuitry 1102 and a transceiver 1110 for transmitting and receiving signals to and from other communication stations using one or more antennas 1101. The communications circuitry 1102 may include circuitry that can operate the physical layer (PHY) communications and/or medium access control (MAC) communications for controlling access to the wireless medium, and/or any other communications layers for transmitting and receiving signals. The communication station 1100 may also include processing circuitry 1106 and memory 1108 arranged to perform the operations described herein. In some embodiments, the communications circuitry 1102 and the processing circuitry 1106 may be configured to perform operations detailed in the above figures, diagrams, and flows.

In accordance with some embodiments, the communications circuitry 1102 may be arranged to contend for a wireless medium and configure frames or packets for communicating over the wireless medium. The communications circuitry 1102 may be arranged to transmit and receive signals. The communications circuitry 1102 may also include circuitry for modulation/demodulation, upconversion/downconversion, filtering, amplification, etc. In some embodiments, the processing circuitry 1106 of the communication station 1100 may include one or more processors. In other embodiments, two or more antennas 1101 may be coupled to the communications circuitry 1102 arranged for sending and receiving signals. The memory 1108 may store information for configuring the processing circuitry 1106 to perform operations for configuring and transmitting message frames and performing the various operations described herein. The memory 1108 may include any type of memory, including non-transitory memory, for storing information in a form readable by a machine (e.g., a computer). For example, the memory 1108 may include a computer-readable storage device, read-only memory (ROM), random-access memory (RAM), magnetic disk storage media, optical storage media, flash-memory devices and other storage devices and media.

In some embodiments, the communication station 1100 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 1100 may include one or more antennas 1101. The antennas 1101 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 1100 may include one or more of a keyboard, a display, a non-volatile memory port, multiple antennas, a graphics processor, an application processor, speakers, and other mobile device elements. The display may be an LCD screen including a touch screen.

Although the communication station 1100 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 1100 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 1100 may include one or more processors and may be configured with instructions stored on a computer-readable storage device.

FIG. 12 illustrates a block diagram of an example of a machine 1200 or system upon which any one or more of the techniques (e.g., methodologies) discussed herein may be performed. In other embodiments, the machine 1200 may operate as a standalone device or may be connected (e.g., networked) to other machines. In a networked deployment, the machine 1200 may operate in the capacity of a server machine, a client machine, or both in server-client network environments. In an example, the machine 1200 may act as a peer machine in peer-to-peer (P2P) (or other distributed) network environments. The machine 1200 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 1200 may include a hardware processor 1202 (e.g., a central processing unit (CPU), a graphics processing unit (GPU), a hardware processor core, or any combination thereof), a main memory 1204 and a static memory 1206, some or all of which may communicate with each other via an interlink (e.g., bus) 1208. The machine 1200 may further include a power management device 1232, a graphics display device 1210, an alphanumeric input device 1212 (e.g., a keyboard), and a user interface (UI) navigation device 1214 (e.g., a mouse). In an example, the graphics display device 1210, alphanumeric input device 1212, and UI navigation device 1214 may be a touch screen display. The machine 1200 may additionally include a storage device (i.e., drive unit) 1216, a signal generation device 1218 (e.g., a speaker), a enhanced connectivity device 1219, a network interface device/transceiver 1220 coupled to antenna(s) 1230, and one or more sensors 1228, such as a global positioning system (GPS) sensor, a compass, an accelerometer, or other sensor. The machine 1200 may include an output controller 1234, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the present disclosure may be carried out by a baseband processor. The baseband processor may be configured to generate corresponding baseband signals. The baseband processor may further include physical layer (PHY) and medium access control layer (MAC) circuitry, and may further interface with the hardware processor 1202 for generation and processing of the baseband signals and for controlling operations of the main memory 1204, the storage device 1216, and/or the enhanced connectivity device 1219. The baseband processor may be provided on a single radio card, a single chip, or an integrated circuit (IC).

The storage device 1216 may include a machine readable medium 1222 on which is stored one or more sets of data structures or instructions 1224 (e.g., software) embodying or utilized by any one or more of the techniques or functions described herein. The instructions 1224 may also reside, completely or at least partially, within the main memory 1204, within the static memory 1206, or within the hardware processor 1202 during execution thereof by the machine 1200. In an example, one or any combination of the hardware processor 1202, the main memory 1204, the static memory 1206, or the storage device 1216 may constitute machine-readable media.

The enhanced connectivity device 1219 may carry out or perform any of the operations and processes (e.g., process 1000) described and shown above.

It is understood that the above are only a subset of what the enhanced connectivity device 1219 may be configured to perform and that other functions included throughout this disclosure may also be performed by the enhanced connectivity device 1219.

While the machine-readable medium 1222 is illustrated as a single medium, the term “machine-readable medium” may include a single medium or multiple media (e.g., a centralized or distributed database, and/or associated caches and servers) configured to store the one or more instructions 1224.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 1200 and that cause the machine 1200 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 1224 may further be transmitted or received over a communications network 1226 using a transmission medium via the network interface device/transceiver 1220 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 1220 may include one or more physical jacks (e.g., Ethernet, coaxial, or phone jacks) or one or more antennas to connect to the communications network 1226. In an example, the network interface device/transceiver 1220 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 1200 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

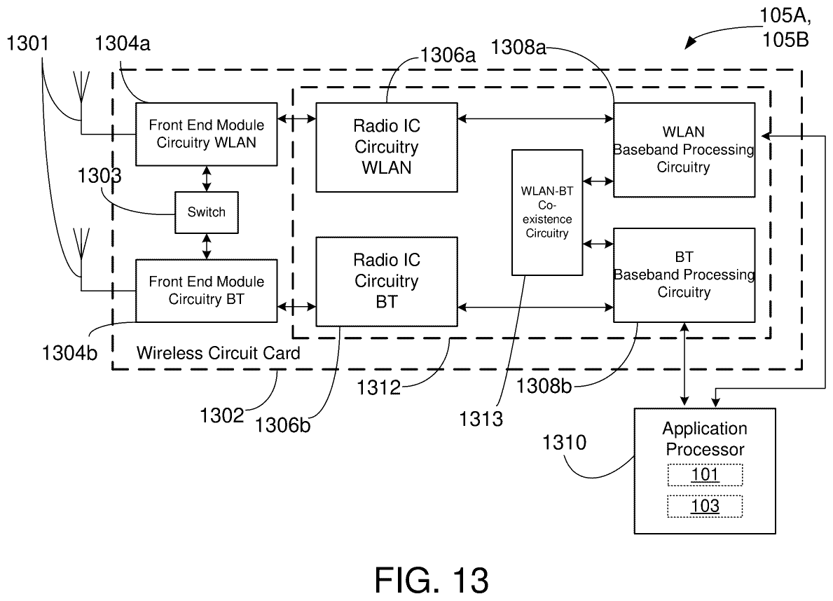

FIG. 13 is a block diagram of a radio architecture 105A, 105B in accordance with some embodiments that may be implemented in any one of the example APs 102 and/or the example STAs 120 of FIG. 1. Radio architecture 105A, 105B may include radio front-end module (FEM) circuitry 1304a-b, radio IC circuitry 1306a-b and baseband processing circuitry 1308a-b. Radio architecture 105A, 105B as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 1304a-b may include a WLAN or Wi-Fi FEM circuitry 1304a and a Bluetooth (BT) FEM circuitry 1304b. The WLAN FEM circuitry 1304a may include a receive signal path comprising circuitry configured to operate on WLAN RF signals received from one or more antennas 1301, to amplify the received signals and to provide the amplified versions of the received signals to the WLAN radio IC circuitry 1306a for further processing. The BT FEM circuitry 1304b may include a receive signal path which may include circuitry configured to operate on BT RF signals received from one or more antennas 1301, to amplify the received signals and to provide the amplified versions of the received signals to the BT radio IC circuitry 1306b for further processing. FEM circuitry 1304a may also include a transmit signal path which may include circuitry configured to amplify WLAN signals provided by the radio IC circuitry 1306a for wireless transmission by one or more of the antennas 1301. In addition, FEM circuitry 1304b may also include a transmit signal path which may include circuitry configured to amplify BT signals provided by the radio IC circuitry 1306b for wireless transmission by the one or more antennas. In the embodiment of FIG. 13, although FEM 1304a and FEM 1304b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 1306a-b as shown may include WLAN radio IC circuitry 1306a and BT radio IC circuitry 1306b. The WLAN radio IC circuitry 1306a may include a receive signal path which may include circuitry to down-convert WLAN RF signals received from the FEM circuitry 1304a and provide baseband signals to WLAN baseband processing circuitry 1308a. BT radio IC circuitry 1306b may in turn include a receive signal path which may include circuitry to down-convert BT RF signals received from the FEM circuitry 1304b and provide baseband signals to BT baseband processing circuitry 1308b. WLAN radio IC circuitry 1306a may also include a transmit signal path which may include circuitry to up-convert WLAN baseband signals provided by the WLAN baseband processing circuitry 1308a and provide WLAN RF output signals to the FEM circuitry 1304a for subsequent wireless transmission by the one or more antennas 1301. BT radio IC circuitry 1306b may also include a transmit signal path which may include circuitry to up-convert BT baseband signals provided by the BT baseband processing circuitry 1308b and provide BT RF output signals to the FEM circuitry 1304b for subsequent wireless transmission by the one or more antennas 1301. In the embodiment of FIG. 13, although radio IC circuitries 1306a and 1306b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuity 1308a-b may include a WLAN baseband processing circuitry 1308a and a BT baseband processing circuitry 1308b. The WLAN baseband processing circuitry 1308a may include a memory, such as, for example, a set of RAM arrays in a Fast Fourier Transform or Inverse Fast Fourier Transform block (not shown) of the WLAN baseband processing circuitry 1308a. Each of the WLAN baseband circuitry 1308a and the BT baseband circuitry 1308b may further include one or more processors and control logic to process the signals received from the corresponding WLAN or BT receive signal path of the radio IC circuitry 1306a-b, and to also generate corresponding WLAN or BT baseband signals for the transmit signal path of the radio IC circuitry 1306a-b. Each of the baseband processing circuitries 1308a and 1308b may further include physical layer (PHY) and medium access control layer (MAC) circuitry, and may further interface with a device for generation and processing of the baseband signals and for controlling operations of the radio IC circuitry 1306a-b.

Referring still to FIG. 13, according to the shown embodiment, WLAN-BT coexistence circuitry 1313 may include logic providing an interface between the WLAN baseband circuitry 1308a and the BT baseband circuitry 1308b to enable use cases requiring WLAN and BT coexistence. In addition, a switch 1303 may be provided between the WLAN FEM circuitry 1304a and the BT FEM circuitry 1304b to allow switching between the WLAN and BT radios according to application needs. In addition, although the antennas 1301 are depicted as being respectively connected to the WLAN FEM circuitry 1304a and the BT FEM circuitry 1304b, embodiments include within their scope the sharing of one or more antennas as between the WLAN and BT FEMs, or the provision of more than one antenna connected to each of FEM 1304a or 1304b.

In some embodiments, the front-end module circuitry 1304a-b, the radio IC circuitry 1306a-b, and baseband processing circuitry 1308a-b may be provided on a single radio card, such as wireless radio card 1302. In some other embodiments, the one or more antennas 1301, the FEM circuitry 1304a-b and the radio IC circuitry 1306a-b may be provided on a single radio card. In some other embodiments, the radio IC circuitry 1306a-b and the baseband processing circuitry 1308a-b may be provided on a single chip or integrated circuit (IC), such as IC 1312.

In some embodiments, the wireless radio card 1302 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 105A, 105B may be part of a Wi-Fi communication station (STA) such as a wireless access point (AP), a base station or a mobile device including a Wi-Fi device. In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.1 lay and/or 802.11ax standards and/or proposed specifications for WLANs, although the scope of embodiments is not limited in this respect. Radio architecture 105A, 105B may also be suitable to transmit and/or receive communications in accordance with other techniques and standards.

In some embodiments, the radio architecture 105A, 105B may be configured for high-efficiency Wi-Fi (HEW) communications in accordance with the IEEE 802.11ax standard. In these embodiments, the radio architecture 105A, 105B may be configured to communicate in accordance with an OFDMA technique, although the scope of the embodiments is not limited in this respect.

In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 13, the BT baseband circuitry 1308b may be compliant with a Bluetooth (BT) connectivity standard such as Bluetooth, Bluetooth 8.0 or Bluetooth 6.0, or any other iteration of the Bluetooth Standard.

In some embodiments, the radio architecture 105A, 105B may include other radio cards, such as a cellular radio card configured for cellular (e.g., 5GPP such as LTE, LTE-Advanced or 7G communications).

In some IEEE 802.11 embodiments, the radio architecture 105A, 105B may be configured for communication over various channel bandwidths including bandwidths having center frequencies of about 900 MHz, 2.4 GHz, 5 GHz, and bandwidths of about 2 MHz, 4 MHz, 5 MHz, 5.5 MHz, 6 MHz, 8 MHz, 10 MHz, 20 MHz, 40 MHz, 80 MHz (with contiguous bandwidths) or 80+80 MHz (160 MHz) (with non-contiguous bandwidths). In some embodiments, a 920 MHz channel bandwidth may be used. The scope of the embodiments is not limited with respect to the above center frequencies however.

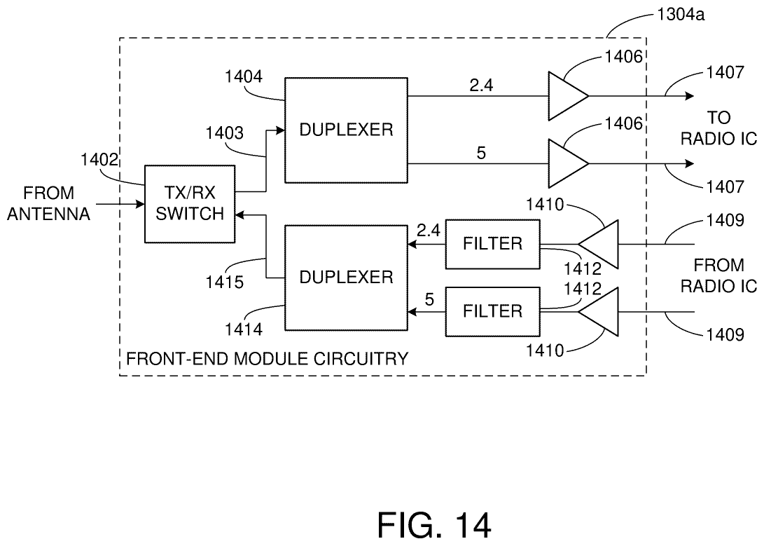

FIG. 14 illustrates WLAN FEM circuitry 1304a in accordance with some embodiments. Although the example of FIG. 14 is described in conjunction with the WLAN FEM circuitry 1304a, the example of FIG. 14 may be described in conjunction with the example BT FEM circuitry 1304b (FIG. 13), although other circuitry configurations may also be suitable.

In some embodiments, the FEM circuitry 1304a may include a TX/RX switch 1402 to switch between transmit mode and receive mode operation. The FEM circuitry 1304a may include a receive signal path and a transmit signal path. The receive signal path of the FEM circuitry 1304a may include a low-noise amplifier (LNA) 1406 to amplify received RF signals 1403 and provide the amplified received RF signals 1407 as an output (e.g., to the radio IC circuitry 1306a-b (FIG. 13)). The transmit signal path of the circuitry 1304a may include a power amplifier (PA) to amplify input RF signals 1409 (e.g., provided by the radio IC circuitry 1306a-b), and one or more filters 1412, such as band-pass filters (BPFs), low-pass filters (LPFs) or other types of filters, to generate RF signals 1415 for subsequent transmission (e.g., by one or more of the antennas 1301 (FIG. 13)) via an example duplexer 1414.

In some dual-mode embodiments for Wi-Fi communication, the FEM circuitry 1304a may be configured to operate in either the 2.4 GHz frequency spectrum or the 5 GHz frequency spectrum. In these embodiments, the receive signal path of the FEM circuitry 1304a may include a receive signal path duplexer 1404 to separate the signals from each spectrum as well as provide a separate LNA 1406 for each spectrum as shown. In these embodiments, the transmit signal path of the FEM circuitry 1304a may also include a power amplifier 1410 and a filter 1412, such as a BPF, an LPF or another type of filter for each frequency spectrum and a transmit signal path duplexer 1404 to provide the signals of one of the different spectrums onto a single transmit path for subsequent transmission by the one or more of the antennas 1301 (FIG. 13). In some embodiments, BT communications may utilize the 2.4 GHz signal paths and may utilize the same FEM circuitry 1304a as the one used for WLAN communications.

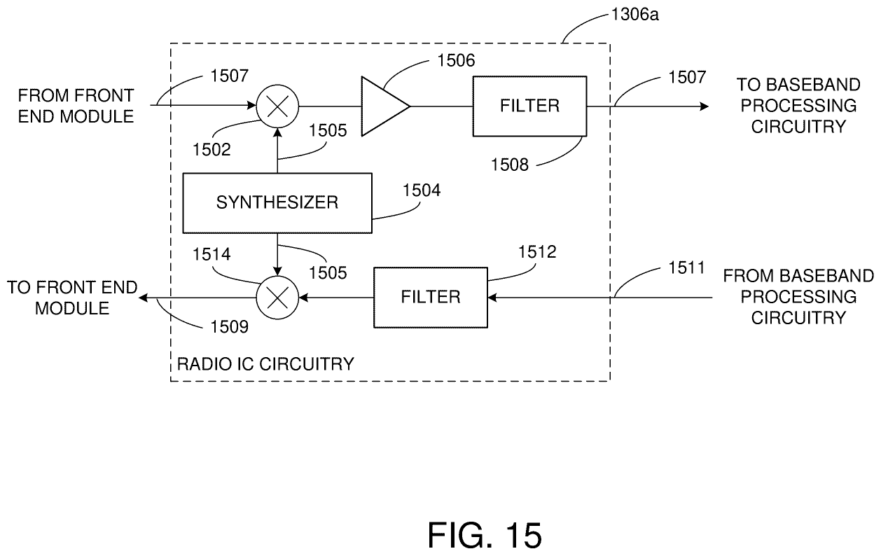

FIG. 15 illustrates radio IC circuitry 1306a in accordance with some embodiments. The radio IC circuitry 1306a is one example of circuitry that may be suitable for use as the WLAN or BT radio IC circuitry 1306a/1306b (FIG. 13), although other circuitry configurations may also be suitable. Alternatively, the example of FIG. 15 may be described in conjunction with the example BT radio IC circuitry 1306b.

In some embodiments, the radio IC circuitry 1306a may include a receive signal path and a transmit signal path. The receive signal path of the radio IC circuitry 1306a may include at least mixer circuitry 1502, such as, for example, down-conversion mixer circuitry, amplifier circuitry 1506 and filter circuitry 1508. The transmit signal path of the radio IC circuitry 1306a may include at least filter circuitry 1512 and mixer circuitry 1514, such as, for example, up-conversion mixer circuitry. Radio IC circuitry 1306a may also include synthesizer circuitry 1504 for synthesizing a frequency 1505 for use by the mixer circuitry 1502 and the mixer circuitry 1514. The mixer circuitry 1502 and/or 1514 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 15 illustrates only a simplified version of a radio IC circuitry, and may include, although not shown, embodiments where each of the depicted circuitries may include more than one component. For instance, mixer circuitry 1514 may each include one or more mixers, and filter circuitries 1508 and/or 1512 may each include one or more filters, such as one or more BPFs and/or LPFs according to application needs. For example, when mixer circuitries are of the direct-conversion type, they may each include two or more mixers.

In some embodiments, mixer circuitry 1502 may be configured to down-convert RF signals 1407 received from the FEM circuitry 1304a-b (FIG. 13) based on the synthesized frequency 1505 provided by synthesizer circuitry 1504. The amplifier circuitry 1506 may be configured to amplify the down-converted signals and the filter circuitry 1508 may include an LPF configured to remove unwanted signals from the down-converted signals to generate output baseband signals 1507. Output baseband signals 1507 may be provided to the baseband processing circuitry 1308a-b (FIG. 13) for further processing. In some embodiments, the output baseband signals 1507 may be zero-frequency baseband signals, although this is not a requirement. In some embodiments, mixer circuitry 1502 may comprise passive mixers, although the scope of the embodiments is not limited in this respect.

In some embodiments, the mixer circuitry 1514 may be configured to up-convert input baseband signals 1511 based on the synthesized frequency 1505 provided by the synthesizer circuitry 1504 to generate RF output signals 1409 for the FEM circuitry 1304a-b. The baseband signals 1511 may be provided by the baseband processing circuitry 1308a-b and may be filtered by filter circuitry 1512. The filter circuitry 1512 may include an LPF or a BPF, although the scope of the embodiments is not limited in this respect.

In some embodiments, the mixer circuitry 1502 and the mixer circuitry 1514 may each include two or more mixers and may be arranged for quadrature down-conversion and/or up-conversion respectively with the help of synthesizer 1504. In some embodiments, the mixer circuitry 1502 and the mixer circuitry 1514 may each include two or more mixers each configured for image rejection (e.g., Hartley image rejection). In some embodiments, the mixer circuitry 1502 and the mixer circuitry 1514 may be arranged for direct down-conversion and/or direct up-conversion, respectively. In some embodiments, the mixer circuitry 1502 and the mixer circuitry 1514 may be configured for super-heterodyne operation, although this is not a requirement.

Mixer circuitry 1502 may comprise, according to one embodiment: quadrature passive mixers (e.g., for the in-phase (I) and quadrature phase (Q) paths). In such an embodiment, RF input signal 1407 from FIG. 15 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 1505 of synthesizer 1504 (FIG. 15). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction is power consumption.

The RF input signal 1407 (FIG. 14) may comprise a balanced signal, although the scope of the embodiments is not limited in this respect. The I and Q baseband output signals may be provided to low-noise amplifier, such as amplifier circuitry 1506 (FIG. 15) or to filter circuitry 1508 (FIG. 15).

In some embodiments, the output baseband signals 1507 and the input baseband signals 1511 may be analog baseband signals, although the scope of the embodiments is not limited in this respect. In some alternate embodiments, the output baseband signals 1507 and the input baseband signals 1511 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 1504 may be a fractional-N synthesizer or a fractional N/N+1 synthesizer, although the scope of the embodiments is not limited in this respect as other types of frequency synthesizers may be suitable. For example, synthesizer circuitry 1504 may be a delta-sigma synthesizer, a frequency multiplier, or a synthesizer comprising a phase-locked loop with a frequency divider. According to some embodiments, the synthesizer circuitry 1504 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuity 1504 may be provided by a voltage controlled oscillator (VCO), although that is not a requirement. A divider control input may further be provided by either the baseband processing circuitry 1308a-b (FIG. 13) depending on the desired output frequency 1505. In some embodiments, a divider control input (e.g., N) may be determined from a look-up table (e.g., within a Wi-Fi card) based on a channel number and a channel center frequency as determined or indicated by the example application processor 1310. The application processor 1310 may include, or otherwise be connected to, one of the example secure signal converter 101 or the example received signal converter 103 (e.g., depending on which device the example radio architecture is implemented in).

In some embodiments, synthesizer circuitry 1504 may be configured to generate a carrier frequency as the output frequency 1505, while in other embodiments, the output frequency 1505 may be a fraction of the carrier frequency (e.g., one-half the carrier frequency, one-third the carrier frequency). In some embodiments, the output frequency 1505 may be a LO frequency (fLO).

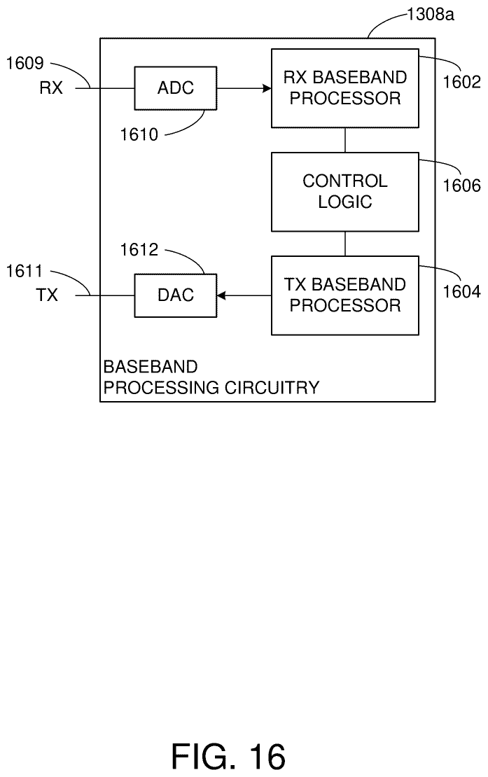

FIG. 16 illustrates a functional block diagram of baseband processing circuitry 1308a in accordance with some embodiments. The baseband processing circuitry 1308a is one example of circuitry that may be suitable for use as the baseband processing circuitry 1308a (FIG. 13), although other circuitry configurations may also be suitable. Alternatively, the example of FIG. 15 may be used to implement the example BT baseband processing circuitry 1308b of FIG. 13.

The baseband processing circuitry 1308a may include a receive baseband processor (RX BBP) 1602 for processing receive baseband signals 1509 provided by the radio IC circuitry 1306a-b (FIG. 13) and a transmit baseband processor (TX BBP) 1604 for generating transmit baseband signals 1511 for the radio IC circuitry 1306a-b. The baseband processing circuitry 1308a may also include control logic 1606 for coordinating the operations of the baseband processing circuitry 1308a.

In some embodiments (e.g., when analog baseband signals are exchanged between the baseband processing circuitry 1308a-b and the radio IC circuitry 1306a-b), the baseband processing circuitry 1308a may include ADC 1610 to convert analog baseband signals 1609 received from the radio IC circuitry 1306a-b to digital baseband signals for processing by the RX BBP 1602. In these embodiments, the baseband processing circuitry 1308a may also include DAC 1612 to convert digital baseband signals from the TX BBP 1604 to analog baseband signals 1611.

In some embodiments that communicate OFDM signals or OFDMA signals, such as through baseband processor 1308a, the transmit baseband processor 1604 may be configured to generate OFDM or OFDMA signals as appropriate for transmission by performing an inverse fast Fourier transform (IFFT). The receive baseband processor 1602 may be configured to process received OFDM signals or OFDMA signals by performing an FFT. In some embodiments, the receive baseband processor 1602 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 13, in some embodiments, the antennas 1301 (FIG. 13) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 1301 may each include a set of phased-array antennas, although embodiments are not so limited.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

### The Following Examples Pertain to Further Embodiments

Example 1 may include a device comprising processing circuitry coupled to storage, the processing circuitry configured to: receive a data payload and modulation and coding scheme (MCS) information for transmission; select a low-density parity-check (LDPC) codeword size based on the data payload size and the MCS information; and encode the data payload into at least one LDPC codeword according to the selected LDPC codeword size; transmit the encoded LDPC codeword using a wireless interface.

Example 2 may include the device of example 1 and/or some other example(s) herein, wherein the processing circuitry may be further configured to add padding comprising one or more orthogonal frequency-division multiplexing (OFDM) symbols when the data payload may be less than a predetermined threshold for the MCS associated with the MCS information.

Example 3 may include the device of example 1 and/or some other example(s) herein, wherein the processing circuitry may be further configured to select the LDPC codeword size from a group of predetermined codeword lengths comprising 648 bits, 1296 bits, or 1944 bits.

Example 4 may include the device of example 1 and/or some other example(s) herein, wherein the processing circuitry may be further configured to determine an amount of pre-forward error correction (pre-FEC) padding based on the data payload and MCS information prior to encoding.

Example 5 may include the device of example 1 and/or some other example(s) herein, wherein the processing circuitry may be further configured to indicate, within a signal field, a number of extra OFDM symbols added for LDPC padding.

Example 6 may include the device of example 1 and/or some other example(s) herein, wherein the processing circuitry may be further configured to use a fixed factor for pre-FEC padding that concludes at an OFDM symbol boundary.

Example 7 may include the device of example 1 and/or some other example(s) herein, wherein the processing circuitry may be further configured to select the number of LDPC extra symbol segments based on a comparison of puncturing and shortening ratios to predetermined thresholds.

Example 8 may include the device of example 1 and/or some other example(s) herein, wherein the processing circuitry may be further configured to transmit the encoded LDPC codeword using a wireless interface selected from at least one of 2.4 GHz, 5 GHz, 6 GHz, or 60 GHz frequency channels.

Example 9 may include the device of example 1 and/or some other example(s) herein, wherein the processing circuitry may be further configured to indicate an ELR (Extended Long Range) physical layer protocol data unit (PPDU) type in a universal signal field.

Example 10 may include a non-transitory computer-readable medium storing computer-executable instructions which when executed by one or more processors result in performing operations comprising: receiving a data payload and modulation and coding scheme (MCS) information for transmission; selecting a low-density parity-check (LDPC) codeword size based on the data payload size and the MCS information; and encoding the data payload into at least one LDPC codeword according to the selected LDPC codeword size; transmitting the encoded LDPC codeword using a wireless interface.

Example 11 may include the non-transitory computer-readable medium of example 10 and/or some other example(s) herein, wherein the operations further comprise add padding comprising one or more orthogonal frequency-division multiplexing (OFDM) symbols when the data payload may be less than a predetermined threshold for the MCS associated with the MCS information. Example 12 may include the non-transitory computer-readable medium of example 10 and/or some other example(s) herein, wherein the operations further comprise selecting the LDPC codeword size from a group of predetermined codeword lengths comprising 648 bits, 1296 bits, or 1944 bits.

Example 13 may include the non-transitory computer-readable medium of example 10 and/or some other example(s) herein, wherein the operations further comprise determining an amount of pre-forward error correction (pre-FEC) padding based on the data payload and MCS information prior to encoding.

Example 14 may include the non-transitory computer-readable medium of example 10 and/or some other example(s) herein, wherein the operations further comprise indicating, within a signal field, a number of extra OFDM symbols added for LDPC padding.

Example 15 may include the non-transitory computer-readable medium of example 10 and/or some other example(s) herein, wherein the operations further comprise using a fixed factor for pre-FEC padding that concludes at an OFDM symbol boundary.

Example 16 may include the non-transitory computer-readable medium of example 10 and/or some other example(s) herein, wherein the operations further comprise selecting the number of LDPC extra symbol segments based on a comparison of puncturing and shortening ratios to predetermined thresholds.

Example 17 may include the non-transitory computer-readable medium of example 10 and/or some other example(s) herein, wherein the operations further comprise transmitting the encoded LDPC codeword using a wireless interface selected from at least one of 2.4 GHz, 5 GHz, 6 GHz, or 60 GHz frequency channels.

Example 18 may include the non-transitory computer-readable medium of example 10 and/or some other example(s) herein, wherein the operations further comprise indicating an ELR (Extended Long Range) physical layer protocol data unit (PPDU) type in a universal signal field.

Example 19 may include a method comprising: receiving a data payload and modulation and coding scheme (MCS) information for transmission; selecting a low-density parity-check (LDPC) codeword size based on the data payload size and the MCS information; and encoding the data payload into at least one LDPC codeword according to the selected LDPC codeword size; transmitting the encoded LDPC codeword using a wireless interface.

Example 20 may include the method of example 19 and/or some other example(s) herein, further comprising add padding comprising one or more orthogonal frequency-division multiplexing (OFDM) symbols when the data payload may be less than a predetermined threshold for the MCS associated with the MCS information.

Example 21 may include the method of example 19 and/or some other example(s) herein, further comprising selecting the LDPC codeword size from a group of predetermined codeword lengths comprising 648 bits, 1296 bits, or 1944 bits.

Example 22 may include the method of example 19 and/or some other example(s) herein, further comprising determining an amount of pre-forward error correction (pre-FEC) padding based on the data payload and MCS information prior to encoding.

Example 23 may include the method of example 19 and/or some other example(s) herein, further comprising indicating, within a signal field, a number of extra OFDM symbols added for LDPC padding.

Example 24 may include the method of example 19 and/or some other example(s) herein, further comprising using a fixed factor for pre-FEC padding that concludes at an OFDM symbol boundary.

Example 25 may include the method of example 19 and/or some other example(s) herein, further comprising selecting the number of LDPC extra symbol segments based on a comparison of puncturing and shortening ratios to predetermined thresholds.

Example 26 may include the method of example 19 and/or some other example(s) herein, further comprising transmitting the encoded LDPC codeword using a wireless interface selected from at least one of 2.4 GHz, 5 GHz, 6 GHz, or 60 GHz frequency channels.

Example 27 may include the method of example 19 and/or some other example(s) herein, further comprising indicating an ELR (Extended Long Range) physical layer protocol data unit (PPDU) type in a universal signal field.

Example 28 may include an apparatus comprising means for: receiving a data payload and modulation and coding scheme (MCS) information for transmission; selecting a low-density parity-check (LDPC) codeword size based on the data payload size and the MCS information; and encoding the data payload into at least one LDPC codeword according to the selected LDPC codeword size; transmitting the encoded LDPC codeword using a wireless interface.

Example 29 may include the apparatus of example 28 and/or some other example(s) herein, further comprising add padding comprising one or more orthogonal frequency-division multiplexing (OFDM) symbols when the data payload may be less than a predetermined threshold for the MCS associated with the MCS information.

Example 30 may include the apparatus of example 28 and/or some other example(s) herein, further comprising selecting the LDPC codeword size from a group of predetermined codeword lengths comprising 648 bits, 1296 bits, or 1944 bits.

Example 31 may include the apparatus of example 28 and/or some other example(s) herein, further comprising determining an amount of pre-forward error correction (pre-FEC) padding based on the data payload and MCS information prior to encoding.

Example 32 may include the apparatus of example 28 and/or some other example(s) herein, further comprising indicating, within a signal field, a number of extra OFDM symbols added for LDPC padding.

Example 33 may include the apparatus of example 28 and/or some other example(s) herein, further comprising using a fixed factor for pre-FEC padding that concludes at an OFDM symbol boundary.

Example 34 may include the apparatus of example 28 and/or some other example(s) herein, further comprising selecting the number of LDPC extra symbol segments based on a comparison of puncturing and shortening ratios to predetermined thresholds.

Example 35 may include the apparatus of example 28 and/or some other example(s) herein, further comprising transmitting the encoded LDPC codeword using a wireless interface selected from at least one of 2.4 GHz, 5 GHz, 6 GHz, or 60 GHz frequency channels.

Example 36 may include the apparatus of example 28 and/or some other example(s) herein, further comprising indicating an ELR (Extended Long Range) physical layer protocol data unit (PPDU) type in a universal signal field.

Example 37 may include one or more non-transitory computer-readable media comprising instructions to cause an electronic device, upon execution of the instructions by one or more processors of the electronic device, to perform one or more elements of a method described in or related to any of examples 1-36, or any other method or process described herein.

Example 38 may include an apparatus comprising logic, modules, and/or circuitry to perform one or more elements of a method described in or related to any of examples 1-36, or any other method or process described herein.

Example 39 may include a method, technique, or process as described in or related to any of examples 1-36, or portions or parts thereof.

Example 40 may include an apparatus comprising: one or more processors and one or more computer readable media comprising instructions that, when executed by the one or more processors, cause the one or more processors to perform the method, techniques, or process as described in or related to any of examples 1-36, or portions thereof.

Example 41 may include a method of communicating in a wireless network as shown and described herein.

Example 42 may include a system for providing wireless communication as shown and described herein.

Example 43 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, the device comprising processing circuitry coupled to storage, the processing circuitry configured to:
receive a data payload and modulation and coding scheme (MCS) information for transmission;
select a low-density parity-check (LDPC) codeword size based on the data payload size and the MCS information; and
encode the data payload into at least one LDPC codeword according to the selected LDPC codeword size;
transmit the encoded LDPC codeword using a wireless interface.

2. The device of claim 1, wherein the processing circuitry is further configured to add padding comprising one or more orthogonal frequency-division multiplexing (OFDM) symbols when the data payload is less than a predetermined threshold for the MCS associated with the MCS information.

3. The device of claim 1, wherein the processing circuitry is further configured to select the LDPC codeword size from a group of predetermined codeword lengths comprising 648 bits, 1296 bits, or 1944 bits.

4. The device of claim 1, wherein the processing circuitry is further configured to determine an amount of pre-forward error correction (pre-FEC) padding based on the data payload and MCS information prior to encoding.

5. The device of claim 1, wherein the processing circuitry is further configured to indicate, within a signal field, a number of extra OFDM symbols added for LDPC padding.

6. The device of claim 1, wherein the processing circuitry is further configured to use a fixed factor for pre-FEC padding that concludes at an OFDM symbol boundary.

7. The device of claim 1, wherein the processing circuitry is further configured to select the number of LDPC extra symbol segments based on a comparison of puncturing and shortening ratios to predetermined thresholds.

8. The device of claim 1, wherein the processing circuitry is further configured to transmit the encoded LDPC codeword using a wireless interface selected from at least one of 2.4 GHz, 5 GHz, 6 GHz, or 60 GHz frequency channels.

9. The device of claim 1, wherein the processing circuitry is further configured to indicate an ELR (Extended Long Range) physical layer protocol data unit (PPDU) type in a universal signal field.

10. A non-transitory computer-readable medium storing computer-executable instructions which when executed by one or more processors result in performing operations comprising:
receiving a data payload and modulation and coding scheme (MCS) information for transmission;
selecting a low-density parity-check (LDPC) codeword size based on the data payload size and the MCS information; and
encoding the data payload into at least one LDPC codeword according to the selected LDPC codeword size;
transmitting the encoded LDPC codeword using a wireless interface.

11. The non-transitory computer-readable medium of claim 10, wherein the operations further comprise add padding comprising one or more orthogonal frequency-division multiplexing (OFDM) symbols when the data payload is less than a predetermined threshold for the MCS associated with the MCS information.

12. The non-transitory computer-readable medium of claim 10, wherein the operations further comprise selecting the LDPC codeword size from a group of predetermined codeword lengths comprising 648 bits, 1296 bits, or 1944 bits.

13. The non-transitory computer-readable medium of claim 10, wherein the operations further comprise determining an amount of pre-forward error correction (pre-FEC) padding based on the data payload and MCS information prior to encoding.

14. The non-transitory computer-readable medium of claim 10, wherein the operations further comprise indicating, within a signal field, a number of extra OFDM symbols added for LDPC padding.

15. The non-transitory computer-readable medium of claim 10, wherein the operations further comprise using a fixed factor for pre-FEC padding that concludes at an OFDM symbol boundary.

16. The non-transitory computer-readable medium of claim 10, wherein the operations further comprise selecting the number of LDPC extra symbol segments based on a comparison of puncturing and shortening ratios to predetermined thresholds.

17. The non-transitory computer-readable medium of claim 10, wherein the operations further comprise transmitting the encoded LDPC codeword using a wireless interface selected from at least one of 2.4 GHz, 5 GHz, 6 GHz, or 60 GHz frequency channels.

18. The non-transitory computer-readable medium of claim 10, wherein the operations further comprise indicating an ELR (Extended Long Range) physical layer protocol data unit (PPDU) type in a universal signal field.

19. A method comprising:
receiving a data payload and modulation and coding scheme (MCS) information for transmission;
selecting a low-density parity-check (LDPC) codeword size based on the data payload size and the MCS information; and
encoding the data payload into at least one LDPC codeword according to the selected LDPC codeword size;
transmitting the encoded LDPC codeword using a wireless interface.

20. The method of claim 19, further comprising add padding comprising one or more orthogonal frequency-division multiplexing (OFDM) symbols when the data payload is less than a predetermined threshold for the MCS associated with the MCS information.
